(19) United States
(12) Patent Application Publication
(10) Pub. No.: US 2009/0198038 A1
(43) Pub. Date: Aug. 6, 2009

(54) Novel Catalysts for the Polymerisation of Carbonyl-Containing or Cyclic Monomers

(75) Inventor: Polly Arnold, Edinburgh (GB)

Correspondence Address: BROMBERG & SUNSTEIN LLP, 125 SUMMER STREET, BOSTON, MA, 02110-1618, US

(73) Assignee: THE UNIVERSITY OF NOTTINGHAM, Nottingham (GB)

(21) Appl. No.: 12/305,789

(22) PCT Filed: Jun. 21, 2007
(86) PCT No.: PCT/GB2007/050348

§ 371 Date: Mar. 16, 2009

(30) Foreign Application Priority Data
Jun. 22, 2006 (GB) 0612392.1

(51) Int. Cl. C08G 63/85; C07F 3/02; C07F 7/22; C08G 69/16

(52) U.S. Cl. 528/283; 568/15; 556/21; 528/313; 528/356

(57) ABSTRACT

The present invention relates to metal/organic complexes of Formula (I), (II), (III), (IV), (V) and (VI) that are useful as catalysts for the polymerisation of carbonyl-containing or cyclic monomers. Typical polymerisation reactions are, for example, those of lactides. R is independently selected at each occurrence from the group comprising: hydrogen, hydrocarbyl and substituted hydrocarbyl, M is a Lewis-acidic metal, and, if present, X is any suitable counter ion.

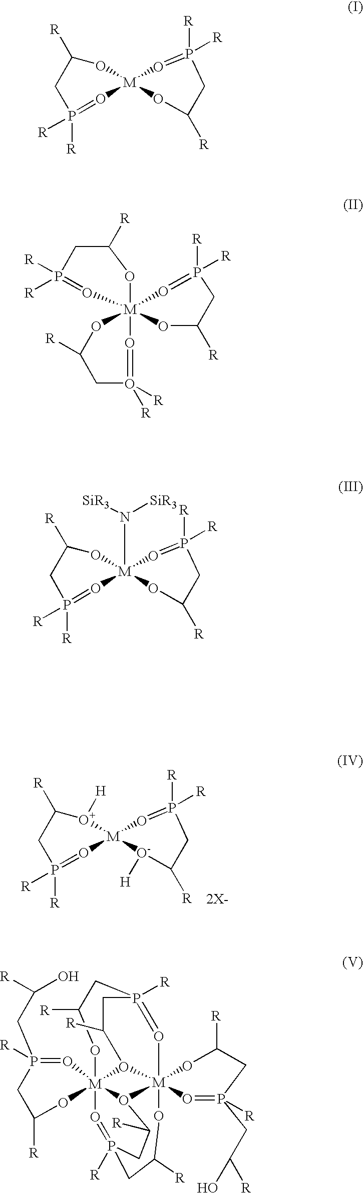

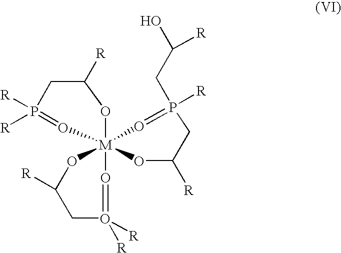

The present invention relates to metal/organic complexes of Formula (I), (II) (III), (IV), (V) and (VI) that are useful as catalysts for the polymerisation of carbonyl-containing or cyclic monomers. Typical polymerisation reactions are, for example, those of lactides.

The compounds of the present invention are metal/organic complexes and are complexes are alkoxides or aryloxides formed from chiral, bidentate ligands. They are particularly useful for stereoselective polymerisation of these monomers. The complexes are alkoxides or aryloxides formed from chiral bidentate ligands and single metal cations and are of the general structures below where R may be selected from the group consisting of hydrogen, hydrocarbyl or substituted hydrocarbyl and M may be any Lewis-acidic metal, for example the s-block, f-block metals or scandium, titanium, vanadium, chromium, manganese, iron, cobalt, nickel, copper, zinc, yttrium, zirconium, tin or aluminium. Preferentially the metal may be an f-block metal. More preferably the metal may be from the lanthanide series, for example europium or erbium.

### DESCRIPTION OF THE PRIOR ART

It is known that metal alkoxides are active ring-opening polymerisation catalysts. A number of metal alkoxides have been used in polymerisation reactions. Examples include tin, aluminium and zinc.

A widely used catalyst for the preparation of poly lactide is tin(II)octanoate [tin(II)bis(2-ethylhexanoate), Sn(Oct)₂] (Chem. Rev. 104: 6147-6176 (2004)). However, the use of a tin-based catalyst may not be appropriate where the polymer is to be used in a biomedical application as tin is toxic and there may be traces of the tin catalyst in the polymer product. Also, tin(II)octanoate requires activation with an alcohol and activity of the catalyst is generally low. The structure of tin(II)octanoate is given below:

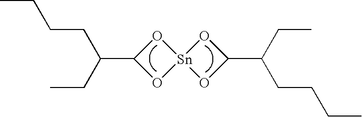

Aluminium alkoxides are less active than tin(II)octanoate (Am. Chem. Soc. 121: 4072-4073 (1999)) and there are concerns about the use of aluminium as catalyst for polymerisation of biomedical polymers as it has been linked to Alzheimer's disease. The structure of an aluminium alkoxide is given below:

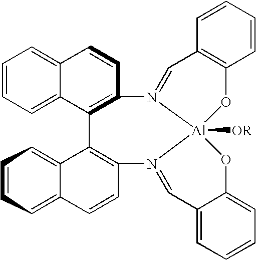

Zinc alkoxides are considered to be non-toxic, however their activity is low.

The use of yttrium and rare earth metals for the catalysis of lactone polymerisation is the subject of U.S. Pat. Nos. 5,028,667 and 5,235,031 and PCT application number WO9619519. None of these documents report the use of chiral ligands to achieve stereoselective polymerisation and therefore the present invention is novel.

Commercial polylactides are synthesised from lactide monomers prepared from a single lactic acid enantiomer in order to obtain stereoregular polymers with a high degree of crystallinity. Polylactides derived from racemic lactide are amorphous with a lower glass transition temperature.

It has been reported that L-polylactide and D-polylactide form a stereocomplex with a melting temperature 50° C. greater than the homochiral polymers. Preparation of such a stereocomplex currently requires parallel ring-opening polymerisation of D-lactide and L-lactide and subsequent combination of the chiral polylactide chains. U.S. Pat. Nos. 4,800,219, 4,766,182 and 4,719,246 describe polylactide compositions with enhanced physical properties. These compositions are obtained by mixing single enantiomers of D- and L-lactide in order to obtain stereocomplex polylactide.

Despite the improved physical properties of the stereocomplex, practical applications of the stereocomplex are restricted by the requirement for separate pools of enantiopure lactide monomers to generate enantiopure polymers i.e. there is a need to devise a method for preparing stereocomplex polylactide from racemic lactide monomer (J. Am. Chem. Soc. 122: 1552-1553 (2000)). An aluminium alkoxide catalyst has been generated that permits stereoselective polymerisation, however the activity of the polymer is low and the molecular weight of the resulting polymers is not sufficient for industrial applications such as packaging (Macromolecular Chemistry and Physics 197(9): 2627-2637 (1996)).

It is therefore an object of the present invention to provide novel metal/organic complexes suitable for use as polymerisation catalysts. Another object of the present invention is to provide improved catalysts which are able to operate under more environmentally friendly conditions e.g. at lower temperatures or in more environmentally friendly solvents. It is a further object of the present invention to provide improved catalysts that are capable of rapidly polymerising a monomer. It is a further object of the present invention to provide improved catalysts with reduced toxicity. It is yet another object of the present invention to provide improved catalysts which are capable of producing higher molecular weight polymers. It is yet another object of the present invention to provide improved catalysts which are capable of producing low polymer dispersity polymers.

### SUMMARY OF THE INVENTION

The present invention fulfils all or some of the above objects of the invention.

The present invention discloses new metal/organic complexes that are useful as catalysts for the polymerisation of carbonyl-containing or cyclic monomers, for example lactide. The complexes are particularly useful for stereoselective polymerisation of these monomers.

According to the first aspect of the present invention, there is provided a compound of Formula (I), (II), (III), (IV), (V) or (VI):

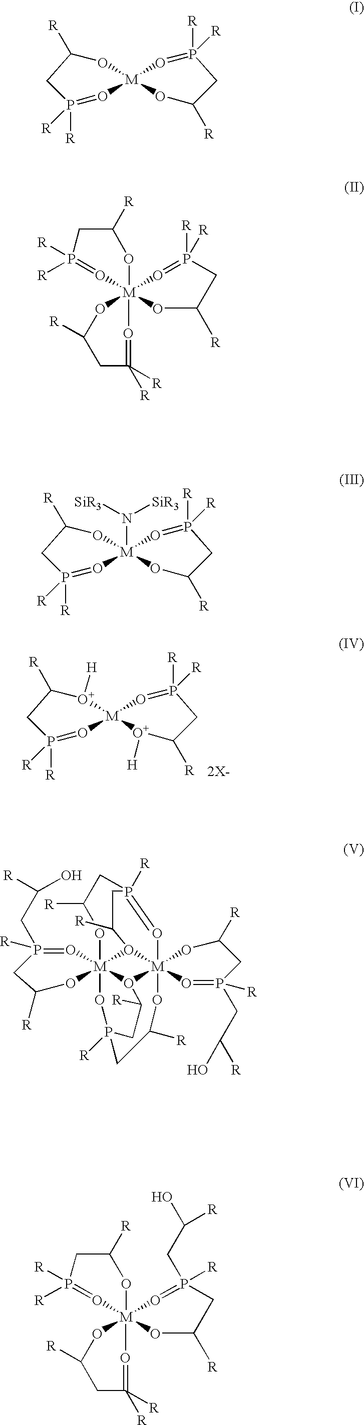

wherein R is independently selected at each occurrence from the group comprising: hydrogen, hydrocarbyl and substituted hydrocarbyl,
M is a Lewis-acidic metal and
X, if present, is any suitable counter ion.

In one embodiment, the complexes are alkoxides or aryloxides formed from chiral bidentate ligands and single metal cations. In an alternative embodiment, the complexes are alkoxides or aryloxides formed from chiral tridentate ligands and double metal cations. In another alternative embodiment, the complexes are alkoxides or aryloxides formed from a mixture of chiral bidentate and chiral tridentate ligands and single metal cations.

The drawings are not intended to limit the invention to any specific stereoisomer. All potential stereoisomers arising from planar, axial or centrosymmetric stereoelements are claimed herein.

In another aspect the present invention also discloses the use of these catalysts for stereoselective polymerisations of carbonyl-containing or cyclic monomers, for example lactide, glycolide, ε-caprolactone or ε-caprolactam.

The use of such stereoselective catalysts confers more precise control over the properties of a polymer and to allow more efficient polymer production. The resulting polymers have a number of applications in the biomedical industry e.g. surgery (tissue or bone repairing, sutures and controlled release drug delivery), food packaging (as a polyethylene alternative), agriculture and the engineering industry.

Inevitably trace amounts of catalyst are present in the resulting polymer and for this reason the catalysts of the present invention are particularly useful in producing polymers used in food and medical applications due to their low toxicity.

An example polymer which can be produced by a catalyst of the present invention is poly lactic acid (PLA). PLA is both biodegradable and bioassimilable. An additional environmental benefit with PLA is that the monomer, D,L-lactide is readily available by the fermentation of corn starch (a carbon neutral process). The molecular weight range of PLA is controllable between 1000 and 500000 g/mol and is dependent upon the catalyst used and conditions employed. The mechanical properties of PLA range from viscous oils and soft elastic plastics to stiff, high strength materials comparable to polyethylene.

In another aspect of the present invention, these catalysts may also be used for asymmetric Lewis-acid catalysed reactions, for example chiral Diels Alder reactions, asymmetric aldol (or aldol derivative) reactions.

### DETAILED DESCRIPTION OF THE INVENTION

In one aspect, the present invention relates to metal/organic complexes of Formula (I), (II) (III), (IV) (V) and (VI) that are useful as catalysts for the polymerisation of carbonyl-containing or cyclic monomers.

In any of the above embodiments, the substituted hydrocarbyl group may be substituted with one or more heteroatoms. Preferred heteroatoms include N, S, O, and Si.

M may be selected from s-block, p-block, d-block and f-block metals. M may be any Lewis-acidic metal, for example lithium, beryllium, sodium, magnesium, potassium, calcium, rubidium, strontium, caesium, barium, francium, radium, scandium, titanium, vanadium, chromium, manganese, iron, cobalt, nickel, copper, zinc, yttrium, zirconium, tin, aluminium, lanthanum, cerium, praseodymium, neodymium, samarium, europium, gadolinium, terbium, dysprosium, holmium, erbium, thulium, ytterbium, lutetium, thorium, protactinium, uranium, neptunium, plutonium, americium, curium, berkelium, californium, einsteinium, fermium, mendelevium, nobelium and lawrencium.

In an embodiment, the metal is selected from magnesium, calcium, scandium, titanium, vanadium, chromium, manganese, iron, cobalt, nickel, copper, zinc, yttrium, zirconium, europium, erbium, tin or aluminium. Preferentially the metal may be an f-block metal. More preferably the metal may be from the lanthanide series, for example europium or erbium. Preferentially the metal is selected from the group comprising: magnesium, calcium, titanium, zinc, yttrium, europium, erbium, ytterbium, tin or aluminium.

In an embodiment, each R group is optionally substituted where chemically possible with 1 to 3 substituents selected from the group consisting of halo, hydroxy, oxo, cyano, mercapto, nitro, (C1-C4)alkyl, and (C1-C4)haloalkyl.

In an embodiment, each R is independently selected from the group comprising:

a) (C1-C6)alkyl, (C2-C6)alkenyl, (C2-C6)alkynyl, (C1-C6)alkoxy, (C1-C6)alkyl-S—, (C1-C6)alkylamino, and di[(C1-C6)alkyl]amino; wherein each of said groups may optionally be substituted where chemically possible with 1 to 3 substituents independently selected from the group consisting of halo, hydroxy, cyano, mercapto, nitro, (C1-C4)alkyl, and (C1-C4)haloalkyl; or
b) 5- to 10-membered heteroaryl containing 1 or 2 ring heteroatoms independently selected from the group consisting of N, S or O; wherein said heteroaryl ring may optionally be substituted with 1 to 3 substituents per ring independently selected from the group comprising: halo, hydroxy, cyano, mercapto, nitro, (C1-C4)alkyl, (C1-C4)haloalkyl, (C2-C4)alkenyl, (C2-C4)alkynyl, (C1-C4)alkoxy, or
c) phenyl, naphthyl, anthracenyl, phenanthranyl, and indenyl, wherein each of the foregoing groups is optionally be substituted with 1 to 3 substituents per ring independently selected from the group comprising: halo, hydroxy, cyano, mercapto, nitro, (C1-C4)alkyl, (C1-C4)haloalkyl, (C2-C4)alkenyl, (C2-C4)alkynyl, (C1-C4)alkoxy.

In a preferred embodiment, each R is independently selected from the group comprising:

a) (C1-C6)alkyl, (C2-C6)alkenyl, and (C2-C6)alkynyl; or
b) 5- or 6-membered-heteroaryl containing 1 or 2 ring heteroatoms independently selected from the group consisting of N, S or O; or
c) phenyl and naphthyl.

When an individual R group is alkyl, it is preferably propyl or butyl. Most preferably it is t-butyl. When an individual R group is an aryl group, it is preferably a phenyl group which may be optionally substituted with 1 to 3 independently chosen substituents selected from halogen, CN, OH, NO₂, C₁₋₄ alkyl and C₁₋₄ alkoxy.

In a second aspect, the invention is related to the use of the catalysts of the present invention for stereoselective polymerisations of carbonyl-containing or cyclic monomers, for example lactide, glycolide, ε-caprolactone or ε-caprolactam.

Not meaning to be bound by theory, it is thought that the mechanism for the ring opening polymerisation (ROP) of D,L-lactide follows the route illustrated in scheme 3a:

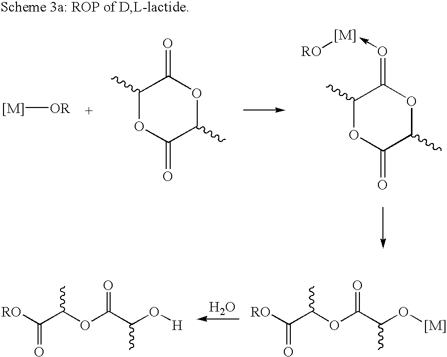

It is already known in the prior art that if one enantiomer of lactide is polymerised, e.g. D-lactide, then the resulting polylactide is the D enantiomer, D-polylactide. Likewise if L-lactide is polymerised the resulting PLA is L-polylactide. It is also known that if L-polylactide and D-polylactide are mixed and annealed, the L and D enantiomers form a more stable stereocomplex which has a melting point 50° C. higher than either L-lactide or D-lactide. The increase in melting point is believed to be due to the complementary interaction between each enantiomer. This is illustrated in scheme 3b:

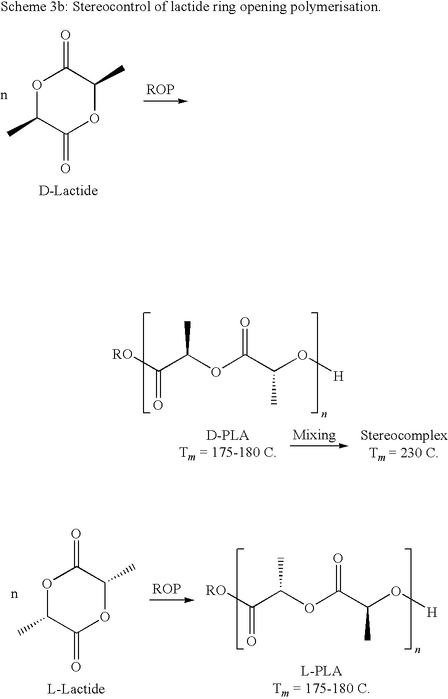

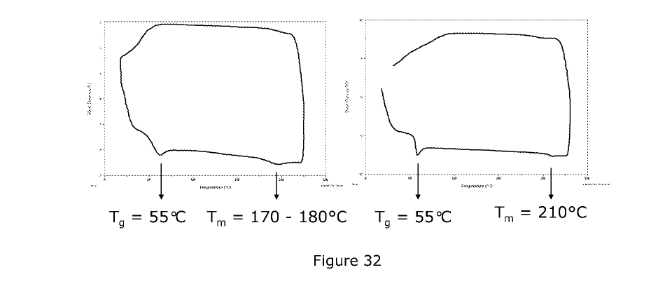

If a racemic mixture of D,L-lactide is polymerised with a racemic mixture of a catalyst of the present invention, a mixture of D- and L-polylactide is produced. Annealing this mixture allows the formation of a stereocomplex. FIG. 32 illustrates that after thermal annealing (180° C., 5 min) the polymer exhibits a sharper T_{g} peak and a higher melting point suggesting the formation of the stereocomplex.

The increased stability and higher melting point of the stereocomplex increases the number of potential uses for the polymer. For example the polymer stereocomplex will have many useful applications in engineering.

### General Procedures

In one embodiment, the novel catalysts are prepared from chiral bidentate ligands as described herein.

One method of preparing the chiral bidentate ligand is illustrated in reaction scheme 1a:

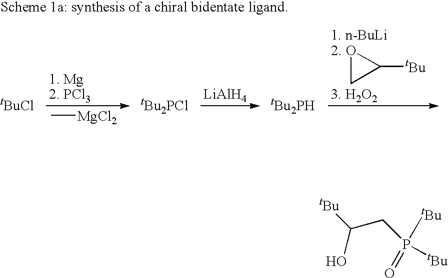

In another embodiment, the novel catalysts are prepared from chiral tridentate ligands.

One method of preparing the chiral tridentate ligands is illustrated in the reaction scheme 1b:

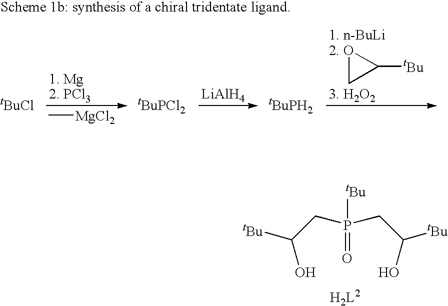

Bimetallic, tridentate ligand complexes (of formula (V)) can be produced by reaction scheme 2a:

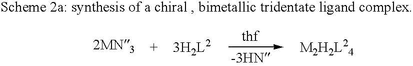

In another embodiment, the novel catalysts are prepared from both chiral bidentate and chiral tridentate ligands.

Mixed bidentate/tridentate ligand complexes (of formula (VI)) can be produced by the reaction scheme 2b:

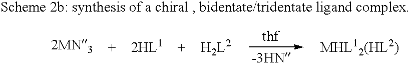

The invention is illustrated by way of example only by the following Figures:

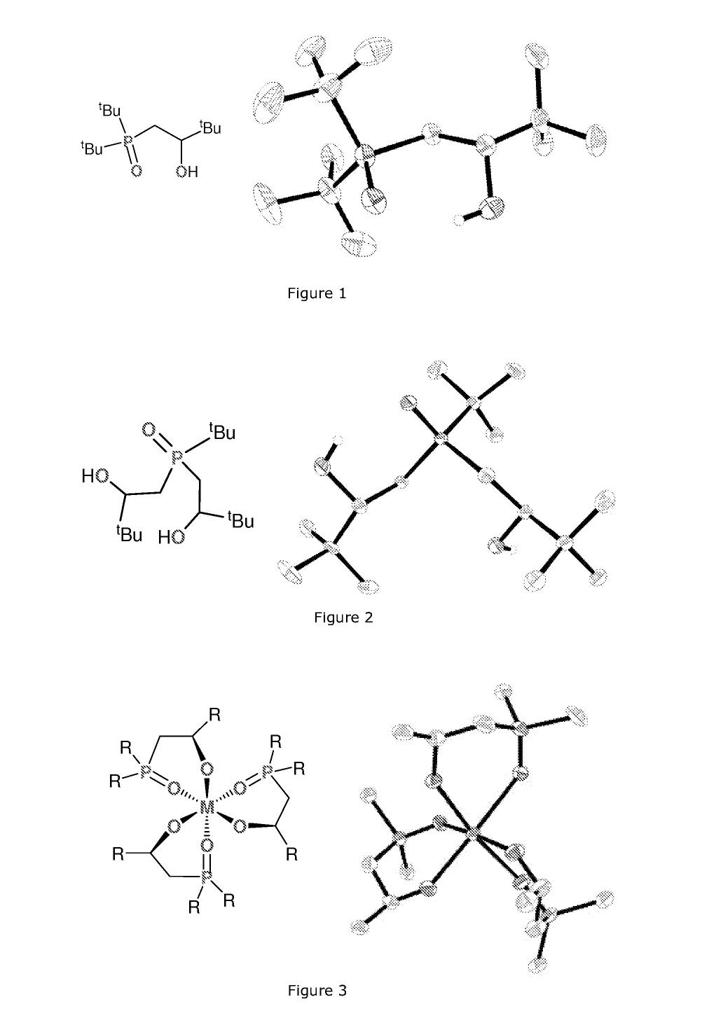

FIG. 1: X-ray crystal structure of the bidentate ligand precursor, HL¹.

FIG. 2: X-ray crystal structure of the tridentate ligand precursor, H₂L².

FIG. 3: X-ray crystal structure of the bidentate ligand complex ML¹₃, formula (II).

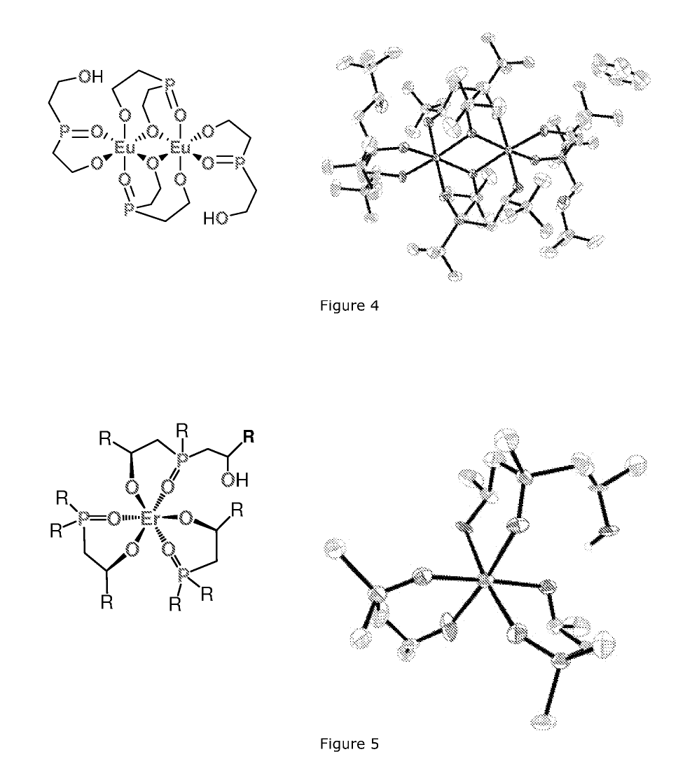

FIG. 4: X-ray crystal structure of the tridentate ligand complex M₂H₂L²₄, formula (V).

FIG. 5: X-ray crystal structure of the mixed bidentate/tridentate ligand complex ML¹₂(HL²), formula (VI)

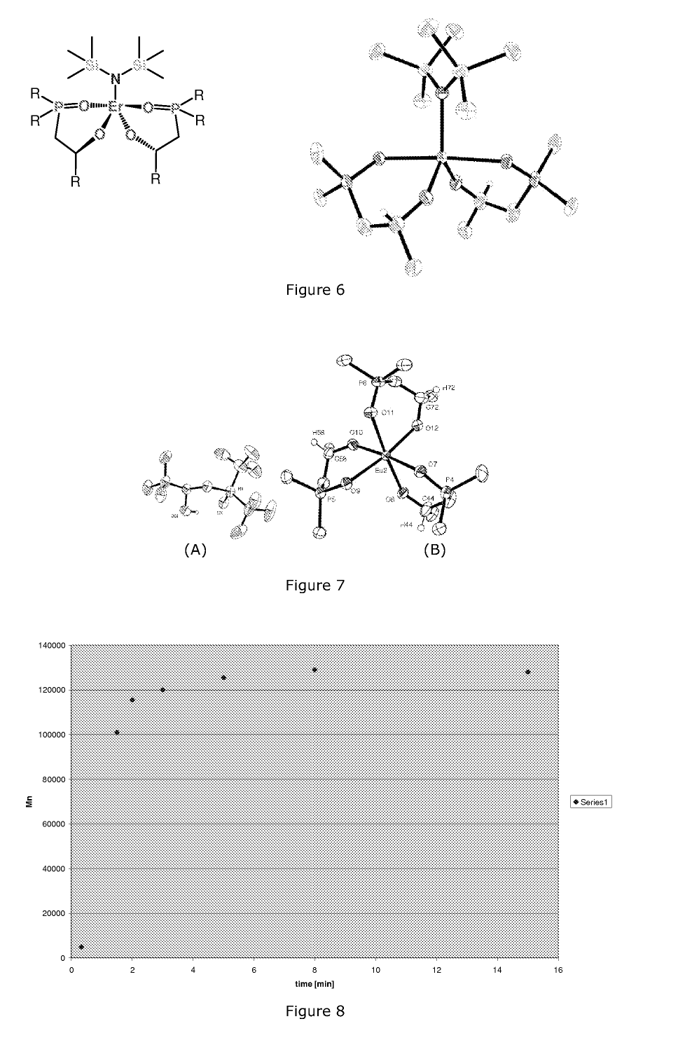

FIG. 6: X-ray crystal structure of the amide ligand complex ML¹₂N″.

FIG. 7A/B: X-ray crystal structures of (A) ligand 1 and (B) catalyst 1.

FIG. 8: Mₙ over time for reactions 1-7.

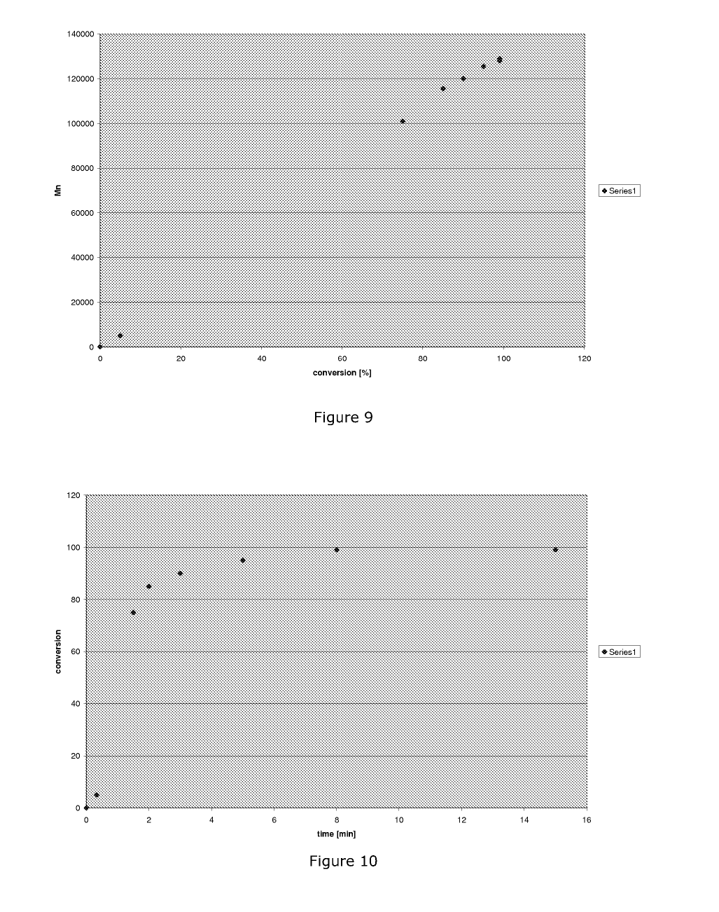

FIG. 9: Mₙ over conversion for reactions 1-7.

FIG. 10: Conversion over time for reactions 1-7.

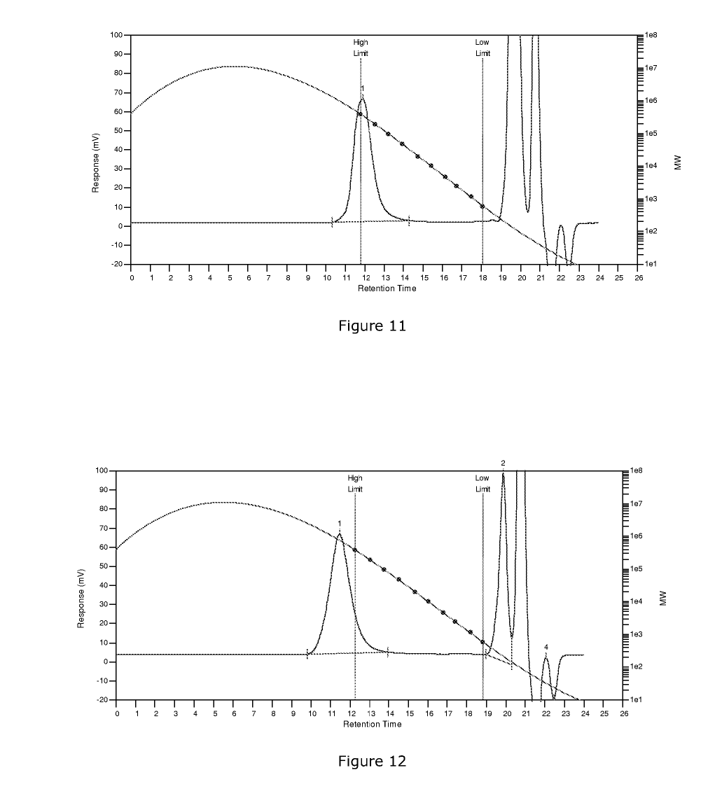

FIG. 11: GPC data for polymer samples from reaction 8.

FIG. 12: GPC data for polymer samples from reaction 9.

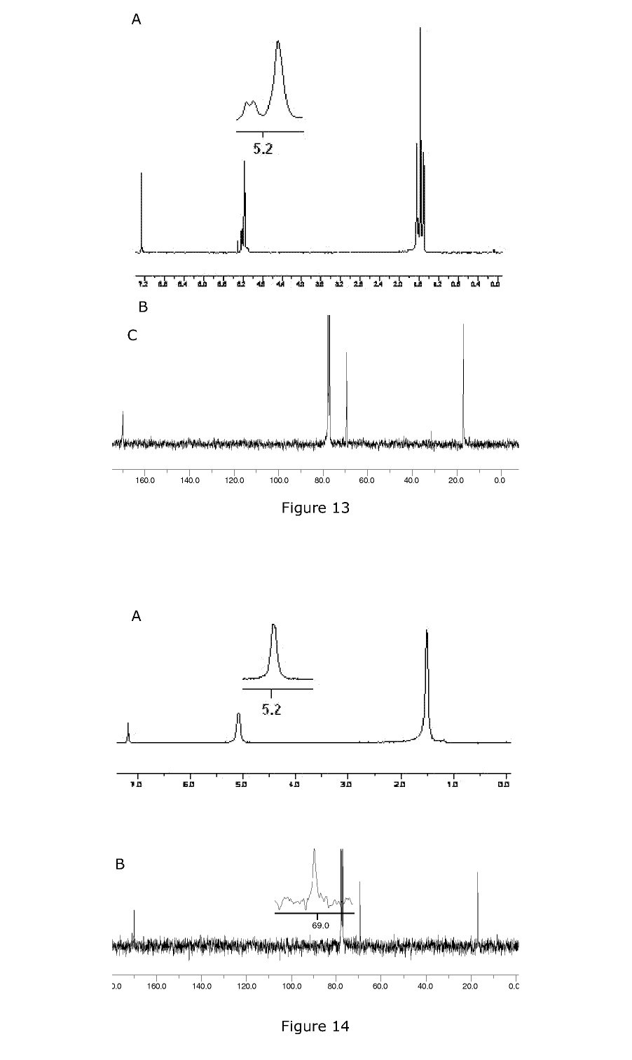

FIGS. 13A/B/C: (A) ¹H NMR, (B) homonuclear decoupled ¹H NHR and (C) ¹³C NMR spectra of polymer produced using D,L-lactide and 1% catalyst 2.

FIGS. 14A/B: (A) standard ¹H NMR and (B) ¹³C NMR spectra for polymer made using L-lactide and 1% catalyst 2.

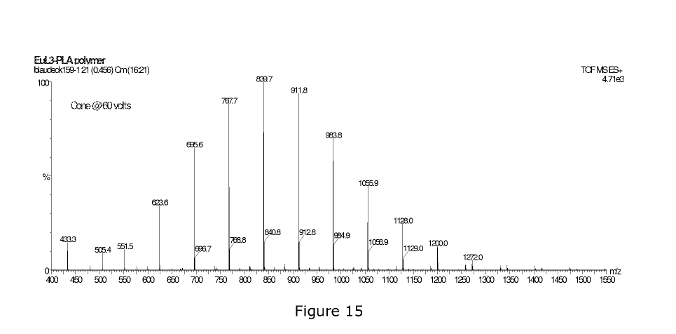

FIG. 15: electrospray mass spectrum of a relatively short chain polymer i.e. n=3 to 9.

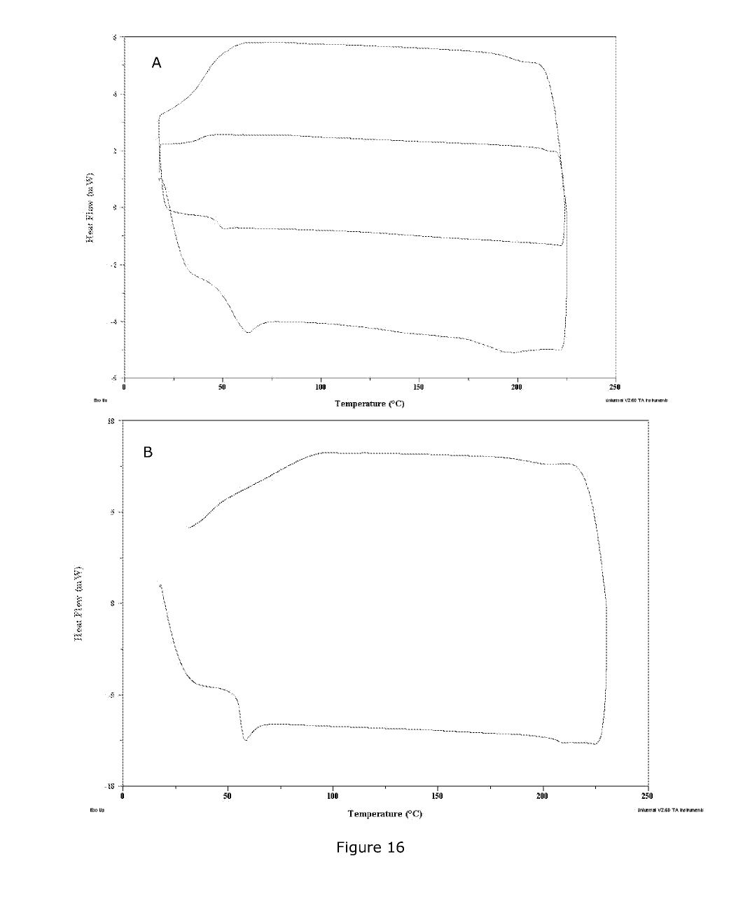

FIG. 16: (A) DSC data for PLA prior to annealing; T_{g}: 55° C., Mp: 180-190° C. (B) DSC data for PLA after annealing at 220° C. for 2 min; sharper T_{g} peak and higher Mp (210° C.).

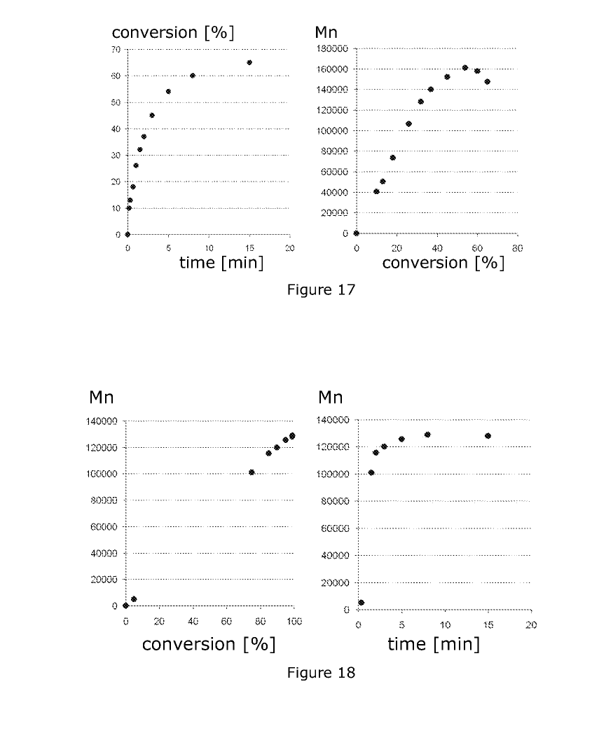

FIG. 17: Polymerisation results in THF for polymerisation of D,L-lactide using ErL¹₃ (1%) at 0° C.

FIG. 18: Polymerisation results in DCM for polymerisation of D,L-lactide using ErL¹₃ (1%) at 0° C.

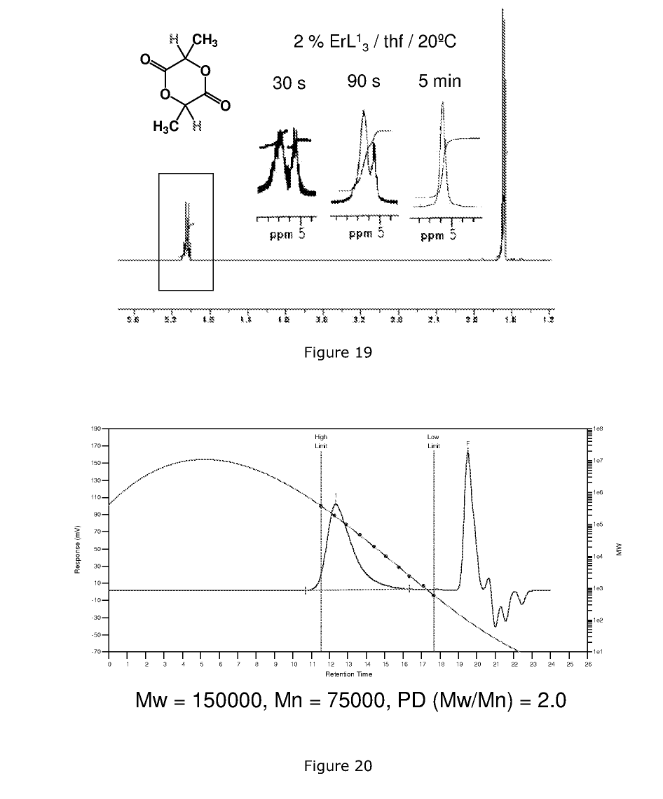

FIG. 19: ¹H-NMR data for the polymerisation reaction.

FIG. 20: Gel permeation chromatography for the polymer detailed in FIG. 19

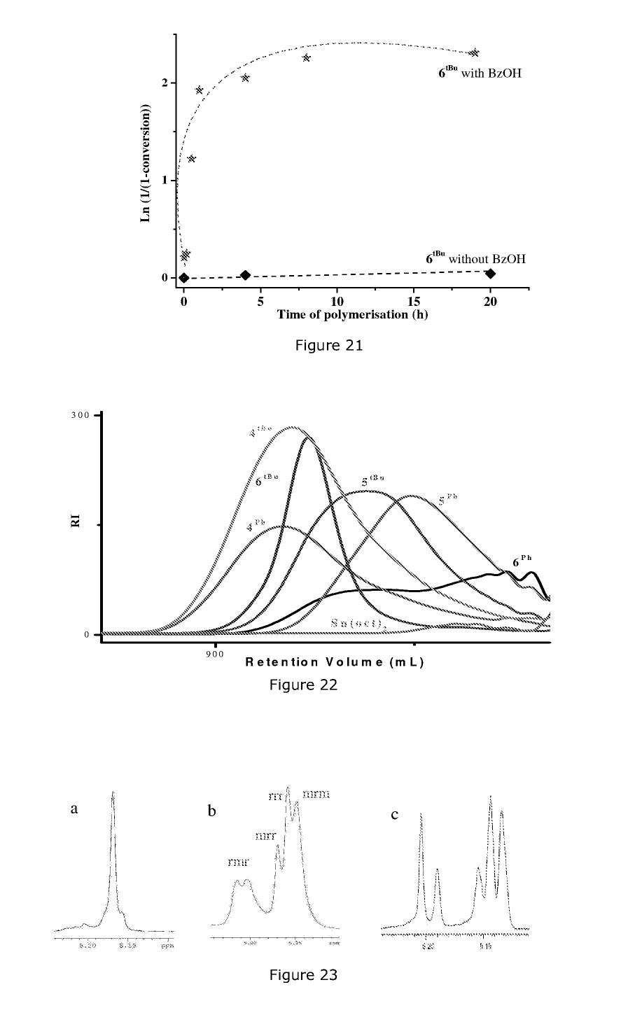

FIG. 21: Data comparison using 6^{tBu} with and without coinitiator benzyl alcohol.

FIG. 22: GPC characterisation for complexes 4-6 and Sn(oct)₂.

FIG. 23: ¹H NMR spectra (300 MHz in CDCl₃) of PLA methine resonances with selective decoupling of PLA methyl resonances: (a) L-PLA prepared by ROP of L-lactide by 4^{tBu}, (b) rac-PLA prepared by ROP of rac-lactide by 4^{tBu} and (c) rac-PLA prepared by ROP of rac-lactide with Sn(Oct)₂ (tin (II)bis(2-ethylhexanoate)).¹⁸

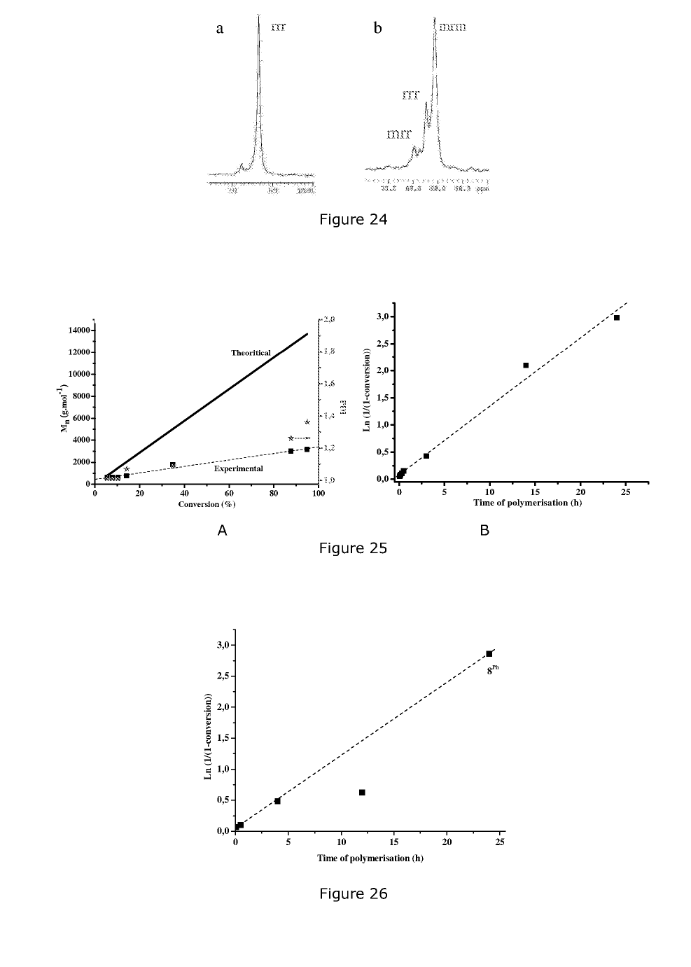

FIG. 24: ¹H NMR spectra (300 MHz in CDCl₃) of PLA methine resonances with selective decoupling of PLA methyl resonances: (a) L-PLA prepared by ROP of L-lactide by 4^{tBu}, (b) rac-PLA prepared by ROP of rac-lactide by 4^{tBu}.

FIG. 25: Mₙ and PDI versus conversion and Ln (1/(1-conv.)) versus the time of polymerisation for the polymerisation of D,L-lactide by 4^{tBu}.

FIG. 26: Conversion versus the time of polymerisation for the polymerisation of D,L-lactide by 8^{Ph}.

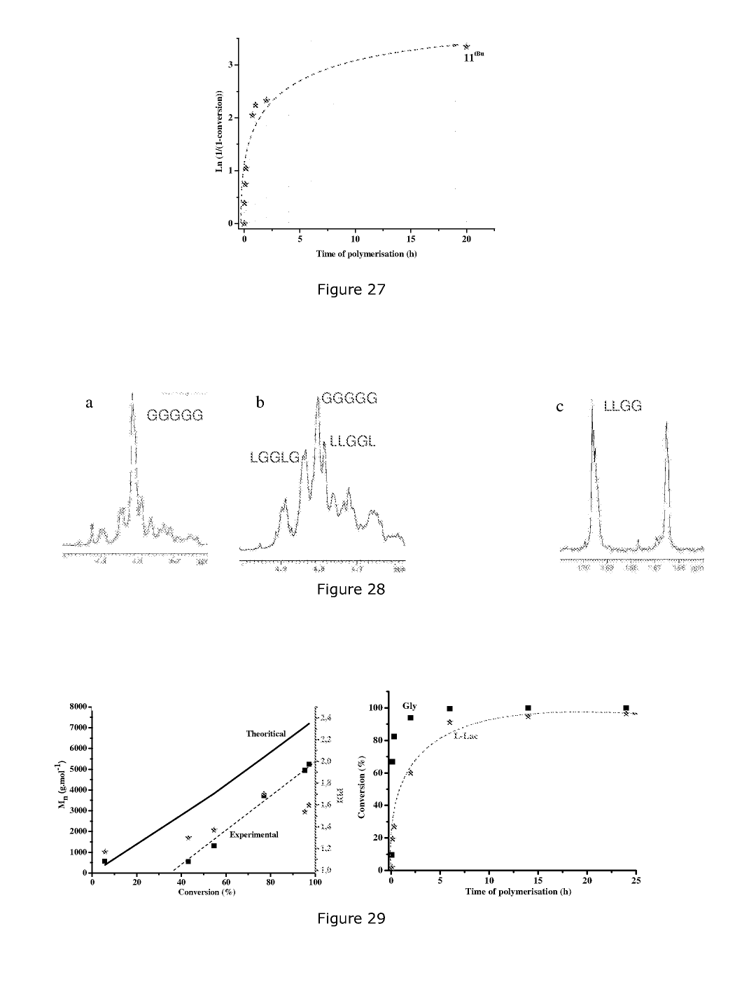

FIG. 27: Conversion versus the time of polymerisation for the polymerisation of D,L-lactide by 11^{tBu}.

FIG. 28: ¹H and ¹³C NMR spectra (300 MHz in CDCl₃) of PLGA. (a) PLGA prepared by ROP using 4^{tBu} after 6 h, (b) PLGA prepared by ROP using 4^{tBu} after 24 h, (c) PLGA prepared by ROP using 4^{tBu} after 24 h.

FIG. 29: Mₙ and PDI versus conversion and conversion versus the time of polymerisation for the copolymerisation of D,L-lactide and glycolide by 4^{tBu}.

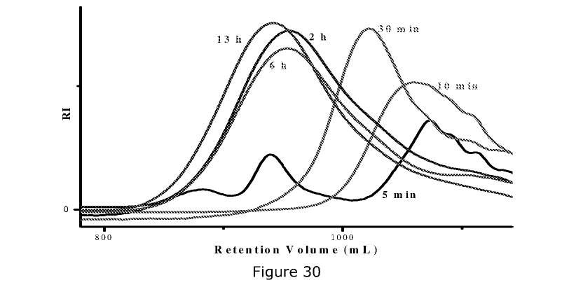

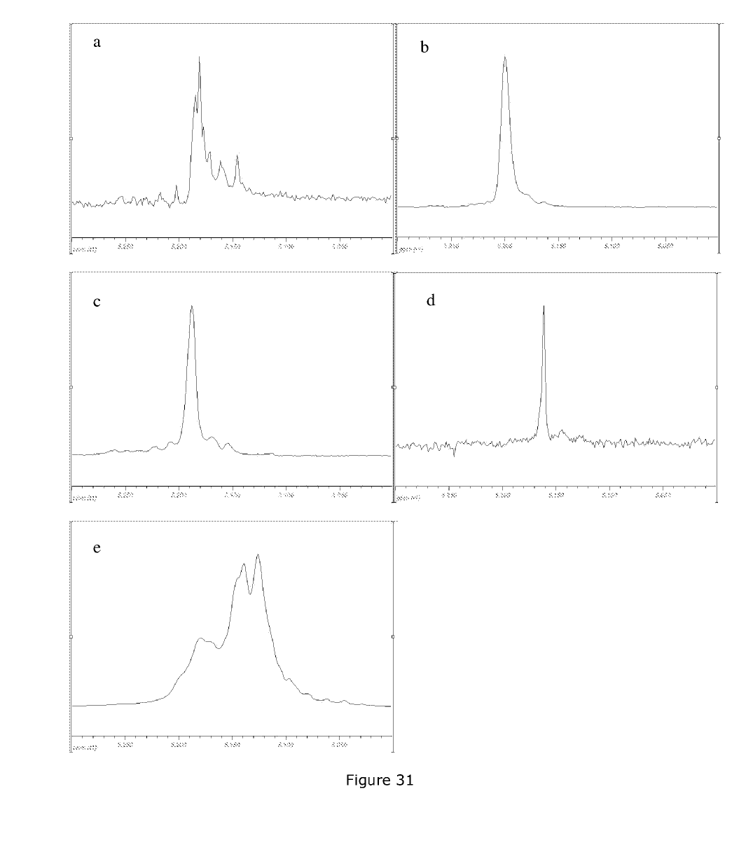

FIG. 30: GPC chromatogram of the copolymerisation of glycolide and lactide using 4^{tBu} following the time of the polymerisation.

FIG. 31a-e: NMR Spectral characterization of polymers.

FIG. 32: differential scanning calorimetry of D,L-PLA produced using a catalyst of the present invention (A) prior to annealing at 180° C. and (B) after annealing at 180° C.

FIG. 1 illustrates an x-ray crystal structure of a ligand used in the preparation of a catalyst of the present invention. The P—O bond length is 1.507 \check{A}, the P—C bond length is 1.816 \check{A} and the O—O bond length is 2.777 \check{A}. Additionally ³¹P-NMR shows a P resonance at δ 65.8 ppm.

FIG. 2 illustrates an x-ray crystal structure of another ligand used in the preparation of a catalyst of the present invention. The P—O bond length is 1.504 \check{A}, the P—C bond length is 1.816 \check{A} and the O—O bond length is 2.787 \check{A}. Additionally ³¹P-NMR shows a P resonance at δ 63.9 ppm.

FIG. 3 illustrates an x-ray crystal structure of a catalyst of the present invention. R is ^{t}Bu and M can be any of Eu, Er, Y or Yb. The M-O═P bond length when M=Er is 2.32 \check{A}, when M=Eu 2.42 \check{A} and when M=Y is 2.37 \check{A}.

FIG. 4 illustrates an x-ray crystal structure of another catalyst of the present invention. The Eu—Eu distance is 3.762 \check{A}.

FIG. 5 illustrates an x-ray crystal structure of another catalyst of the present invention. This catalyst has both bidentate and tridentate ligands.

FIG. 6 illustrates an x-ray crystal structure of another catalyst of the present invention. The Er—N bond length is 2.28 \check{A} [compared with 2.21 \check{A} in Er[N(SiMe₃)₂]₃, the Er—O═P bond length is 2.29 \check{A} and the Er—O—C bond length is 2.09 \check{A}.

FIG. 7A illustrates an x-ray crystal structure of ligand 1.

FIG. 7B illustrates an x-ray crystal structure of catalyst 1.

FIG. 8 illustrates the Mₙ over time for reactions 1-7. This shows that after 8 minutes the molecular weight of the polymer has reached its maximum value of 130000 g/mol for reactions 1-7.

FIG. 9 illustrates the Mₙ over conversion for reactions 1-7. This shows that the 100% conversion corresponds to a molecular weight of 130000 g/mol.

FIG. 10 illustrates the conversion over time for reactions 1-7. This shows that 100% conversion is reached after 8 minutes reaction time.

FIG. 11 illustrates gel permeation chromatography data from reactions 8 of example 4.

FIG. 12 illustrates gel permeation chromatography data from reactions 9 of example 4.

FIG. 13 illustrates (A) standard ¹H NMR, (B) homonuclear decoupled ¹H NHR and (C) ¹³C NMR spectra of polymer produced using D,L-lactide and 1% catalyst 2.

FIG. 14 illustrates (A) standard ¹H NMR and (B) ¹³C NMR spectra for polymer made using L-lactide and 1% catalyst 2.

FIG. 15 illustrates electrospray mass spectrum of a relatively short chain polymer i.e. n=3 to 9.

FIG. 16 illustrates (A) DSC data for PLA prior to annealing; T_{g}: 55° C., Mp: 180-190° C. (B) DSC data for PLA after annealing at 220° C. for 2 min; sharper T_{g} peak and higher Mp (210° C.).

FIG. 17 illustrates the polymerisation results in THF for the polymerisation of D,L-Lactide using ErL¹₃ (1%) at 0° C. This demonstrates the rapid conversion of D,L-lactide to PLA using ErL¹₃ in THF (60% of the D,L-lactide is converted to PLA in under 10 minutes). The maximum conversion that can be achieved is approximately 65%. FIG. 17 also illustrates the maximum molecular weight of PLA that can be achieved using THF as the solvent is 160000 g/mol. The molecular weight (length) of the polymer can be tailored by altering the reaction time.

FIG. 18 illustrates the polymerisation results in DCM for the polymerisation of D,L-Lactide using ErL¹₃ (1%) at 0° C. This demonstrates that higher conversion levels (up to 100% conversion) can be achieved using ErL¹₃ in DCM (than for THF). However, the maximum molecular weight is lower when DCM is the solvent as opposed to THF. The reaction time required to achieve nearly full conversion is approximately 8 minutes.

Table 7 provides a comparison of the use of ErL¹₃ (the catalyst presented in FIG. 18) and prior art catalysts to catalyse the conversion of D,L-lactide to PLA. Much more rapid conversion is achieved irrespective of the solvent used (FIGS. 17 and 18 illustrate the use of both coordinating and non-coordinating solvents) when ErL¹₃ is employed rather than a catalyst of the prior art. Additionally, the molecular weight of the polymer produced using this catalyst is much higher than for polymers produced using prior art catalysts. Higher molecular weight polymers hydrolyse slower than shorter polymers which is beneficial for important instances e.g. longer-lasting polymers for engineering applications. Other benefits of using ErL¹₃ include low polymer dispersion values and low toxicity.

TABLE 7

| | Sn(Oct)₂ | (SB)AlOR | ErL¹₃ |
|---|---|---|---|
| Cat:Lactide | — | 1:100 | 1:200 |
| >90% conv. | 24 h | 40 h | 5 min |
| Solvent | Toluene | Toluene | DCM |
| Temperature | 70° C. | 70° C. | −18° C. |
| MW [g/mol] | 100000 | 15000 | >300000 |
| PD | 1.8 | 1.06 | 1.3 |
| Stereocontrol | none | >90% | 70% |
| Toxicity | high | low | low |
| Activation | yes | no | no |

Table 8 provides examples of polymerization under different reaction conditions. The reactions for catalysts of the present invention (table 8, DCM) were carried out at −18° C. which is much lower than the temperature traditional methods employing Sn(Oct)₂ are carried out at. This illustrates the economic and environmental benefits of using a catalyst of the present invention e.g. greater energy efficiency. Additionally, because the reaction employing a catalyst of the present invention may be carried out in a range of solvents, (see FIGS. 17 and 18) this allows a greater degree of choice with regard to other environmental and economic considerations.

TABLE 8
ROP of D,L-lactide

| | T | ErL¹₃ | time | Mn | | conv. |
|---|---|---|---|---|---|---|
| Solvent | [° C.] | [%] | [min] | [g/mol] | PD | [%] |
| DCM | −18 | 0.5 | 2 | 289000 | 1.25 | 70 |
| DCM | −18 | 0.5 | 10 | 400000 | 1.31 | >99 |
| DCM | −18 | 1.0 | 8 | 129000 | 1.41 | >99 |
| Melt | 180 | 1.0 | 10 | 71000 | 1.91 | >99 |

FIG. 19 provides ¹H-NMR data for the polymerisation reaction using 2% ErL¹₃ in THF at 20° C. The three portions of spectra at ca. 5 ppm are for the C—H resonances and are well separated from the methyl (CH₃) resonances at ca 1.6 ppm. The left spectrum (marked “30s”) corresponds to the monomer which possesses two close-lying resonances as seen in the spectrum. As the polymerisation progresses, the monomer is ring-opened (e.g. the mechanism given in scheme 3a). Only one 1H resonance is obtained from the protons present in the polymer chain (attached to the same carbon atom as the methyl groups), indicating that the protons are equivalent due to the formation of an isotactic chain.

FIG. 20 illustrates gel permeation chromatography for the polymer detailed in FIG. 19 (2% ErL¹₃, THF, 20° C.), using a CHCl₃/polystyrene standard. As can be seen, the peak at retention time ˜13 min is unsymmetrical and is near the “high limit” (for reliable detection). The following values can be derived from the graph Mw=150000, Mn=75000 and PD (Mw/Mn)=2.0

FIG. 21 provides data for the comparison of the reaction using 6^{tBu} with and without coinitiator benzyl alcohol.

FIG. 22 illustrates GPC characterisation for complexes 4-6 and Sn(oct)₂.

FIG. 23 illustrates ¹H NMR spectra (300 MHz in CDCl₃) of PLA methine resonances with selective decoupling of PLA methyl resonances: (A) shows L-PLA prepared by ROP of L-lactide by 4^{tBu}, (B) shows rac-PLA prepared by ROP of rac-lactide by 4^{tBu} and (C) shows rac-PLA prepared by ROP of rac-lactide with Sn(Oct)₂ (tin (II)bis(2-ethylhexanoate).

FIG. 24 illustrates ¹H NMR spectra (300 MHz in CDCl₃) of PLA methine resonances with selective decoupling of PLA methyl resonances: (A) shows L-PLA prepared by ROP of L-lactide by 4^{tBu} and (B) rac-PLA prepared by ROP of rac-lactide by 4^{tBu}.

FIG. 25 illustrates Mₙ and PDI versus conversion and Ln (1/(1-conv.)) versus the time of polymerisation for the polymerisation of D,L-lactide by 4^{tBu}.

FIG. 26 illustrates the conversion versus the time of polymerisation for the polymerisation of D,L-lactide by 8^{Ph}

FIG. 27 illustrates the conversion versus the time of polymerisation for the polymerisation of D,L-lactide by 11^{tBu}.

FIG. 28 illustrates ¹H and ¹³C NMR spectra (300 MHz in CDCl₃) of PLGA. (A) shows PLGA prepared by ROP using 4^{tBu} after 6 h, (B) shows PLGA prepared by ROP using 4^{tBu} after 24 h and (C) shows PLGA prepared by ROP using 4^{tBu} after 24 h.

FIG. 29 illustrates Mₙ and PDI versus conversion and conversion versus the time of polymerisation for the copolymerisation of D,L-lactide and glycolide by 4^{tBu}.

FIG. 30 illustrates a GPC chromatogram of the copolymerisation of glycolide and lactide using 4^{tBu} following the time of the polymerisation.

FIG. 31 illustrates NMR spectral characterization of polymers:

a) methine region of the homonuclear decoupled ¹H-NMR for entry 1. Integration of the iii peak corresponds to 26.2%. ¹H-NMR δ(CDCl₃): 5.146, 5.161, 5.171, 5.178, 5.181, 5.185, 5.202 [ppm].
b) methine region of the homonuclear decoupled ¹H-NMR for entry 2. Integration of the iii peak corresponds to 88.8%. ¹H-NMR δ(CDCl₃): 5.103, 5.181, 5.200 [ppm].
c) methine region of the homonuclear decoupled ¹H-NMR for entry 3. Integration of the iii peak corresponds to 78.7%. ¹H-NMR δ(CDCl₃): 5.144, 5.160, 5.178, 5.198, 5.211, [ppm].
d) methine region of the homonuclear decoupled ¹H-NMR for entry 4. Integration of the iii peak corresponds >99%. ¹H-NMR δ(CDCl₃): 5.151 ppm.
e) methine region of the homonuclear decoupled ¹H-NMR for entry 5. Integration of the iii peak corresponds to 36.1%.

¹H-NMR δ(CDCl₃): 5.097, 5.126, 5.139, 5.165, 5.179, [ppm].

FIG. 32 illustrates differential scanning calorimetry of D,L-PLA produced using a catalyst of the present invention (A) prior to annealing at 180° C. and (B) after annealing at 180° C.

Specific embodiments of the present invention are illustrated in the following examples. The examples should no be interpreted as limiting to the scope of the present invention.

### EXAMPLES

### Example 1

### This Example Illustrates the Synthesis of Proligands

### Synthesis of HL^{R}

The synthesis of the proligand requires three steps. First a double Grignard reaction between magnesium tertiobutyl chloride and PBr₃ yields ^{t}Bu₂PBr (Scheme 4). The compound was obtained as a yellow oil and purified by distillation under reduced pressure (10⁻² mbar); pure ^{t}Bu₂PBr was isolated as a colourless oil, characterised by ¹H and ³¹P NMR spectroscopy.

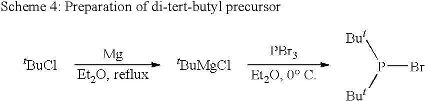

^{t}Bu₂PBr was treated with LiAlH₄, yielding ^{t}Bu₂PH, which was subsequently treated with nBuLi to make LiP^{t}Bu₂ which was treated with 3,3-dimethyl-epoxybutane, and the resulting compound oxidised with H₂O₂ to give the targeted proligand HL^{R} in a modified procedure based on that of Genov D., Kresinski R., Tebby J., J. Org. Chem., 1998, 63, 2574.

The general synthesis for HL^{R}: R=^{t}Bu 1, R=Ph 2 is shown Scheme 5. An analogue R-HL^{R} 1a was synthesised by a R-epoxide following the same procedure.

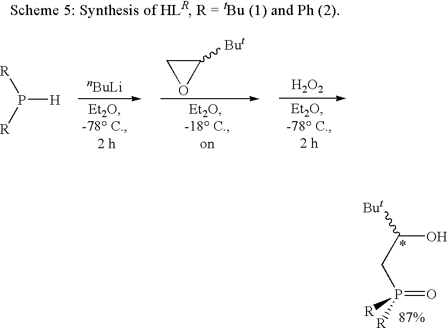

### Synthesis of LiL^{R}

A THF solution of HL^{Ph} 2 was treated with nBuLi, yielding LiL^{Ph} 3 (Scheme 6).

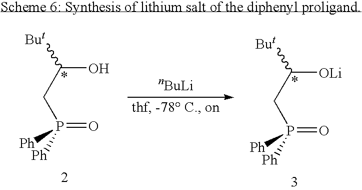

### Example 2

### This Example Illustrates the Synthesis of Catalysts

A range of metal complexes of L^{R} were synthesised using a variety of different metal starting materials, as shown in scheme 7. All reactions were conducted in toluene at 80° C. overnight.

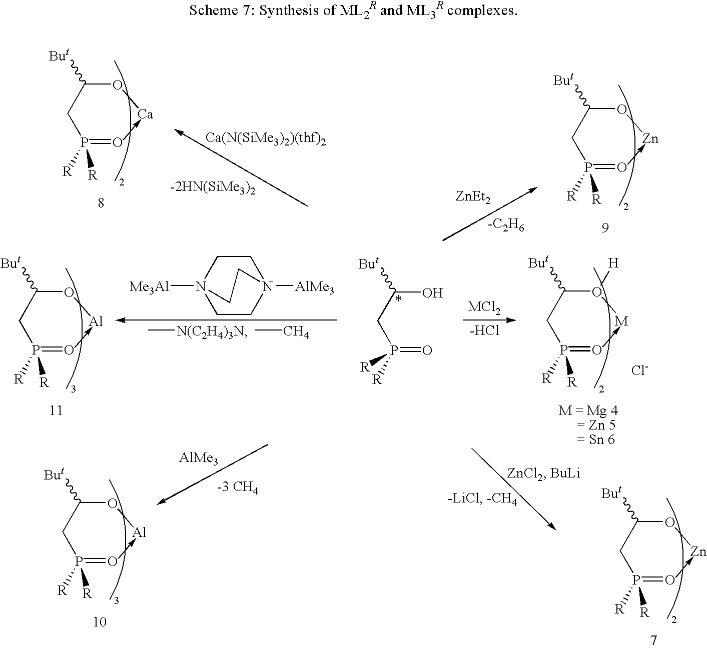

All the complexes were characterised by ¹H and ³¹P and some also by mass spectroscopy analysis and X-Ray crystallography.

Synthesis of Catalysts from MCl₂/HL^{R}

In this route, a metal dichloride salt was treated with two equivalents of the ligand in toluene at 70° C. overnight (scheme 8). It was envisaged that the elimination of HCl would provide a good driving force for the reaction.

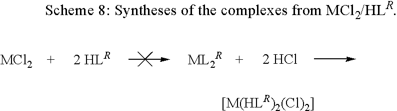

This reaction had limited success; the treatment of MCl₂ (M=Mg, Zn, Sn) with two equivalents of HL^{R} affords [M(HL^{R})₂(Cl)₂]M=Mg (4), Zn (5), and Sn (6) respectively, in excellent yield.

Two magnesium complexes were synthesised from MgCl₂ with two equivalents of HL^{R} affords [Mg(HL^{R})₂(Cl)₂]HL^{R}=1 (4^{tBu}), 1a (4a) the R,R-4^{tBu} analogue and 2 (4^{Ph}).

Complex 4^{tBu} was isolated in a yield of 70.1%, the ³¹P NMR spectrum contains two resonances (70.0 and 70.6 pm) and ¹H NMR spectrum contains a broad singlet at 5.22 ppm (O—H). The mass spectrum results shows m/z (11.5%)=582.6 [4^{tBu}-HCl] and m/z (7.1%)=546.6 [4^{tBu}-2HCl]. After contact of 4^{tBu} with water a new complex (scheme 9) is formed with a molecule of water coordinated to the magnesium.

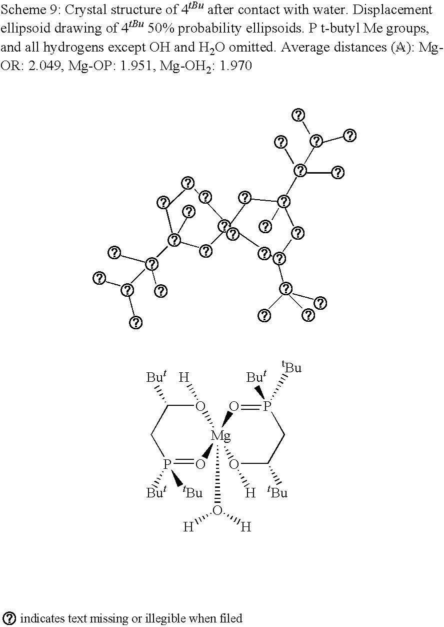

The C₂-symmetric chirality is confirmed by a single crystal X-ray diffraction study of 4^{tBu}.H₂O; Scheme 9 shows the molecular structure of the SS-diastereomer.

The ³¹P NMR spectrum of the diastereomerically pure complex 4a contains only one resonance at 69.8 ppm and the ¹H NMR spectrum contains a broad resonance (OH) at 5.77 ppm.

The complex 4Ph was isolated in a yield of 75.5%. The resonance for the OH is significantly changed upon complexation from 5.22 ppm (4^{tBu}) to 3.65 ppm (4^{Ph}). The mass spectrometric analysis shows m/z (8.49%)=663.1 [4^{Ph}-HCl].

Two zinc complexes were synthesised from ZnCl₂ with two equivalents of HL^{R} affords [Zn(HL^{R})₂(Cl)₂]HL^{R}=1 (5^{tBu}), and 2 (5^{Ph}).

Complex 5^{tBu} was isolated in a yield of 81.9%; the ³¹P NMR spectrum contains one resonance at 72.6 pm, and the ¹H NMR spectrum contains a broad singlet at 4.63 ppm (OH) in, opposition at 5.22 ppm in ¹H NMR for 4^{tBu}. The mass spectrum shows m/z (10.5%)=623.0 [5^{tBu}-HCl] and m/z (7.1%)=587.0 [5^{tBu}-2HCl]. A single tablet grown which is not representative of the bulk shows scheme 10.

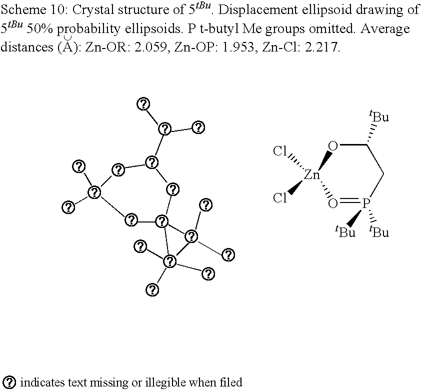

From scheme 10 and the presence of HCl, it is apparent that the formation of [Zn(HL^{R})₂(Cl)₂] is certainly favourite instead of ZnL^{R}₂ for the zinc as the magnesium.

Complex 5^{Ph} was isolated in a yield of 85.0%; the ³¹P NMR spectrum contains one resonance at 41.6 pm, and the ¹H NMR spectrum contains a broad singlet at 4.95 ppm (OH). The mass spectrum shows m/z (7.3%)=667.4 [5^{Ph}-2HCl].

Two tin complexes were synthesised from SnCl₂ with two equivalents of HL^{R} affords [Sn(HL^{R})₂(Cl)₂]HL^{R}=1 (6^{tBu}), and 2 (6^{Ph}). In opposition of the magnesium and zinc catalysts which were air and moisture sensitive, the both tin complexes were air and moisture stable.

Complex 6^{tBu} was isolated in a yield of 80.7%, the ³¹P NMR spectrum contains one resonance at 76.1 pm, and the ¹H NMR spectrum doesn't show any broad singlet for OH. In opposition with 4^{tBu} at 5.22 ppm in the ¹H NMR spectrum. Further more the two compounds were really different, 4^{tBu} was a colourless solid while 6^{tBu} was colourless glue but the mass spectrum shows m/z (39.1%)=677.3 [6^{tBu}-HCl], m/z (29.8%)=640.3 [6^{tBu}-2HCl].

Complex 6^{Ph} was isolated in a yield of 88.5%; the ³¹P NMR spectrum contains one resonance at 39.7 pm, and the ¹H NMR spectrum contains a broad singlet at 4.61 ppm (OH). In opposition with 6^{tBu} which possessed any OH bond in ¹H NMR. The mass spectrum shows m/z (30.3%)=721.0 [6^{Ph}-2HCl].

Synthesis of Catalysts from MCl₂/LiL^{R}

To avoid the presence of chloride in the final complexes, salt elimination method was carried out. The ligand 2 was treated with n-BuLi to afford the lithium salt 3, which was treated with ½ an equivalent of ZnCl₂ in toluene, overnight at −78° C. (scheme 11).

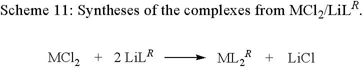

Complex 7^{Ph} was isolated in a yield of 74.2%; the ³¹P NMR spectrum contains one resonance at 40.0 pm, and the ¹H NMR doesn't contains a resonance OH, in opposition of 5^{Ph} (4.95 ppm); the aromatic resonances were broader than in the 5^{Ph}.

The mass spectrum shows m/z (100.0%)=610.0 [7^{Ph}-^{t}Bu].

Synthesis of Catalysts from MN″₂/HL^{R}

To avoid the presence of chloride in the final complexes, amine elimination method was carried out. Two equivalents of ligands 1 and 2 were added to a solution of one equivalent of Ca[N(SiMe₃)₂]₂(thf)₂ in thf, overnight at −78° C. (scheme 12).

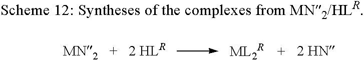

For the complex 8^{tBu}; the ³¹P NMR spectrum contains one resonance at 69.4 pm, and the ¹H NMR spectrum doesn't contain a resonance OH, just the resonances expected. The reaction was carried out in NMR so the yield wasn't optimised but it was possible to remove the volatile compound to afford colourless solid 8^{tBu}.

Complex 8^{Ph} was isolated in a yield of 37.8%, low yield due to a problem in the purification; the ³¹P NMR spectrum contains one resonance at 20.0 pm, and the ¹H NMR doesn't contain a resonance OH, just the resonances expected.

Some NMR experiments were carried out with CaCl₂/HL^{R} to compare but they didn't get any concrete results to study due to the insoluble character of CaCl₂.

Synthesis of Catalysts from MR₂/HL^{R}

To avoid the presence of chloride in the final complexes, alkyl elimination method was carried out. Two equivalents of ligands 1 and 2 were added to a solution of one equivalent of ZnEt₂/toluene in toluene, overnight at 70° C. (scheme 13).

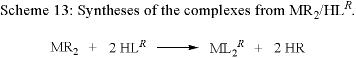

The complexes 9^{tBu} and 9^{Ph} were difficult to isolate and characterise, due to the low quantity of starting material (0.17 ml and 0.15 ml for ZnEt₂ in the synthesis of 9^{tBu} and 9^{Ph}, respectively). Meanwhile, the ³¹P NMR spectrum contains a resonance at 68.8 ppm for 9^{tBu} and at 52.0 ppm for 9^{Ph}. The ¹H NMR spectrum of 9^{Ph} doesn't show any resonance for OH.

In comparison, the zinc complexes synthesised via MCl₂/HL^{R} (5) have shown in the ¹H NMR spectrum a OH resonance for the both ligands.

The ³¹P NMR spectrum contains a higher resonance for 9^{Ph} (52.0 ppm) than for 5^{Ph} (41.6 ppm) or 7^{Ph} (40.0 ppm).

After all the studies in the zinc complexes, it was choosing to concentrate the research on the method which has synthesised 7^{Ph}. It's allowed a product without HCl 5^{Ph} and it's safer than use diethyl zinc 9^{Ph}.

Synthesis of Catalysts from MR₃/HL^{R}

Following previous research in our group, we are targeted C₃-symmetric racemic complexes with main group element by the utilisation of trisalkyl aluminium (AlMe₃ and DABAL-Me₃)

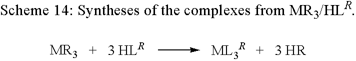

Firstly, a solution of three equivalents of 1 or 2 was added to a solution of one equivalent of AlMe₃/hexanes in deuterated benzene, overnight at 70° C. to afford complexes 10^{tBu} and 10^{Ph} respectively (scheme 14) which were difficult to isolate and characterise, due to the low quantity of starting material (0.14 ml and 0.1 ml for AlMe₃. Meanwhile, the ³¹P NMR spectrum contains a resonance at 79.3 ppm for 10^{tBu} and at 51.0 ppm for 10^{Ph}.

Secondly, a solution of six equivalents of 1 or 2 was added to a solution of one equivalent of DABAL-Me₃ in toluene, overnight at 70° C. to afford complexes 11^{tBu} and 11^{Ph} respectively (scheme 15).

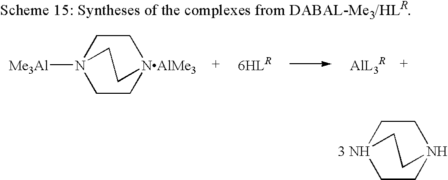

The ³¹P NMR spectrum contains a resonance at 78.7 ppm for 11^{tBu} and at 51.0 ppm for 11^{Ph} which are results close to these obtain with 10^{tBu} (79.3 ppm) and 10^{Ph} (51.0 ppm). The ¹H NMR spectra contain no extra proton resonance for the both complexes 11.

In the case of the tris-tert-butyl aluminium complexes (10^{tBu} and 11^{tBu}) the phosphorus resonances were the highest obtained during theses complexations.

Synthesis of Catalysts from MN″₃/HL^{R}

Treatment of Ln(N{SiMe₃}₂)₃ (Ln=Y) with three equivalents of 1 in thf at low temperature affords LnL₃^{R} Ln=Y (12), in excellent yield, after recrystallization from pentane (scheme 16), complex 12 is colourless.

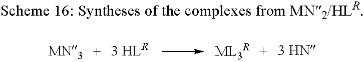

Complex 12^{tBu} was isolated in a yield of 90.0%, the ³¹P NMR spectrum contains two resonances at 70.5 pm and 70.1 ppm, the composition was confirmed by microanalysis, and complex 12a (made by 1a R-HL^{tBu}) was isolated in a yield of 86.5%, the ³¹P NMR spectrum contains one resonance at 68.6 ppm.

Comparison of the ¹H and ³¹P{¹H} NMR spectra of solutions of 12 and 12a show what appears to be predominantly the same compound, save for an additional, minor set of resonances in the spectra of 12, which correspond to a minor diastereomer, RRS-/SSR-Y^{tBu}, present in about 20% of the total yield. The C₃-symmetric chirality is confirmed by a single crystal X-ray diffraction study of 12.

Complex 12^{Ph} was isolated in a yield of 75.1% (yield non-optimised); the ³¹P NMR spectrum contains three 42.8 ppm (major), 42.3 and 42.0 ppm (minor); an additional, minor set of resonances in the ¹H NMR spectrum of 12^{Ph}, which correspond to a minor diastereomer, RRS-/SSR-12Ph, present in about 30% of the total yield

### Example 3

### Syntheses of Other Catalyst Complexes

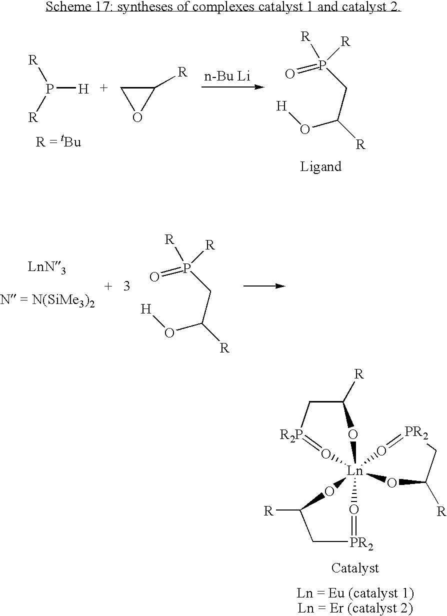

Preparation of (t-Bu)₂P(O)CH₂CH(t-Bu)OH, HL (Ligand)

A 1.6 M hexane solution of n-BuLi (15 ml, 25 mmol) was added dropwise to a solution of 3,3-dimethyl-epoxybutane (2.1 g, 25 mmol) and t-Bu₂PH (3.6 g, 25 mmol) in 20 ml of THF at −78° C., using a 250 ml 3-neck flask equipped with reflux condenser and dropping funnel. The reaction mixture was stirred for 2 hours at room temperature and boiled for 20 min at reflux. After cooling to 0° C. the solution was slowly hydrolysed with 10 ml of 10% aqueous NH₄Cl and oxidized by dropwise addition of 30 ml of 30% H₂O₂. The organic layer was separated and the aqueous solution extracted with THF (3×10 ml). The combined organic layer was dried over Na₂SO₄, filtered and evaporated to dryness. The obtained colourless oil was dissolved in 10 ml CHCl₃ and chromatographed on silica gel (60, 230-400 mesh) using 90% CHCl₃/10% MeOH as eluent. Two bands were collected. The first band was identified as starting material (epoxide). The second band was collected and evaporated to dryness. The white precipitate obtained was recrystallised from pentane. Yield 3.2 g (50%).

¹H-NMR δ(C₆D₆): 1.1 (18H, dd, ²J_{PC}=4.5 Hz, P—C(CH₃)₃); 1.15 (9H, s, C—CH₃); 1.7-1.9 (2H, m, CH₂); 4.0-4.1 (1H, m, CH) [ppm]. ¹³C-NMR δ(C₆D₆): 22.2 (1C, d, J_{PC}=56.8 Hz, CH₂); 25.7 (3C, CH₃); 25.9 (3C, CH₃); 26.3 (3C, CH₃); 35.3 (1C, d, J_{PC}=56.8 Hz, P—CMe₃); 35.5 (1C, CMe₃); 36.1 (1C, d, J_{PC}=58.1 Hz, P—CMe₃); 75.7 (1C, d, ²J_{PC}=5.7 Hz, C—OH) [ppm]. ³¹P-NMR δ(C₆D₆): 77.6 ppm. MP: 98° C. Analysis Found: C, 63.22%; H, 11.72; calc. C, 64.1%; H, 11.9%.

### Preparation of EuL₃ (Catalyst 1)

A solution of 3 equivalents (400 mg, 1.5 mmol) of HL in 10 ml of THF was added over 10 min to a solution of one equivalent (308 mg, 0.5 mmol) of Eu[N(SiMe₃)₂]₃ in 10 ml of THF at 0° C. and stirred overnight at RT (scheme 17). All volatile compounds were removed under reduced pressure and the residual yellow solid recrystallised from pentane to afford pale yellow catalyst 1. Yield 440 mg (94%).

¹H-NMR δ(C₆D₆): −7.6 (3H, CH); −6.1 (27H, ^{t}Bu); −4.6 (3H, CH₂); −1.4 (3H, CH₂); 0.4 (27H, ^{t}Bu); 9.1 (27H, ^{t}Bu). 31P-NMR δ(C₆D₆): 69.9 ppm. Analysis Found: C, 53.78%; H, 9.48%; calc. C, 53.9%; H, 9.6%.

### Preparation of ErL₃ (Catalyst 2)

A solution of HL (533 mg, 0.82 mmol) in 10 ml of THF was added over 10 min to a solution of one equivalent (647 mg, 2.5 mmol) of Er[N(SiMe₃)₂]₃ in 10 ml of THF at 0° C. and stirred overnight at RT (scheme 17). All volatile compounds were removed under reduced pressure and the residual solid recrystallised from pentane to afford pale pink catalyst 2. Yield 720 mg (93%).

¹H-NMR δ(C₆D₆): −9.15 (6×t-Bu H); 24.14 (3×t-Bu H). No other resonances observed. Analysis Found: C, 52.90%; H, 9.61%; calc. C, 53.0%; H, 9.5%.

### Structure of the Ligand-Precursor and the Complexes

FIG. 7A shows the displacement ellipsoid drawing of compound 150% probability ellipsoids. All hydrogens except alcohol OH omitted for clarity. Selected distance (A): ligand P1-O1 1.5065(15) and FIG. 7B shows the displacement ellipsoid drawing of catalyst 1 (isostructural with compound 3) 50% probability ellipsoids. All hydrogens except P t-butyl Me groups and all hydrogens except chiral CH omitted for clarity. Selected distances (\check{A}): catalyst 1 Eu2-O7-2.449(4), Eu2-O8-2.191(4), Eu2-P4-3.5627(17).

### Example 4

### Experimental Data for the Ligand, Catalyst 1 and Catalyst 2

| Compound | Ligand | Catalyst 1 | Catalyst 2 |
|---|---|---|---|
| Chemical formula | C₁₄H₃₁O₂P | C_{42.88}H₉₁EuO₆P₃ | C₄₇H₁₀₂ErO₆P₃ |
| Mᵣ | 262.36 | 947.53 | 1023.46 |
| Cell setting, space | Monoclinic, Cc | Triclinic, P-1 | Triclinic, P-1 |
| group | | | |
| a, b, c (\check{A}) | 11.1977 (12), | 12.9404 (11), | 13.0457 (12), |
| | 18.210 (2), | 19.945 (2), | 19.8700 (18), |
| | 8.6934 (10) | 20.522 (2) | 20.4567 (18) |
| α, β, γ (°) | 90.00, | 82.448 (2), | 82.631 (2), |
| | 110.145 (2), | 84.774 (2), | 85.360 (2), |
| | 90.00 | 84.625 (2) | 84.781 (2) |
| V (\check{A}³) | 1664.2 (3) | 5211.0 (13) | 5224.3 (8) |
| Z | 4 | 4 | 4 |
| Dₓ (Mg m⁻³) | 1.047 | 1.208 | 1.301 |
| Radiation type | Mo Kα | Mo Kα | Mo Kα |
| No. of reflections | 4990 | 7097 | 11270 |
| for cell parameters | | | |
| φ range (°) | 2.3-27.5 | 2.2-27.0 | 2.2-27.0 |
| μ (mm⁻¹) | 0.16 | 1.33 | 1.74 |
| Temperature (K) | 150 (2) | 150 (2) | 150 (2) |
| Crystal form, colour | Block, colourless | Tablet, colourless | Tablet, pale pink |
| Crystal size (mm) | 0.57 × 0.40 × 0.24 | 0.21 × 0.20 × 0.10 | 0.48 × 0.40 × 0.12 |
| Diffractometer | Bruker SMART APEX | Bruker SMART APEX | Bruker SMART1000 |
| | CCD area detector | CCD area detector | CCD area detector |
| Data collection | ω | ω | ω |
| method | | | |
| Absorption | None | Multi-scan (based | Multi-scan (based |
| correction | | on symmetry- | on symmetry- |
| | | related | related |
| | | measurements) | measurements) |
| Tₘᵢₙ | — | 0.767 | 0.714 |
| Tₘₐₓ | — | 0.878 | 1.000 |
| No. of measured, | 7095, 3615, 3436 | 47775, 23452, 17404 | 42004, 22629, 15205 |
| independent and | | | |
| observed | | | |
| parameters | | | |
| Criterion for | I > 2σ(I) | I > 2σ(I) | I > 2σ(I) |
| observed reflections | | | |
| Rᵢₙₜ | 0.037 | 0.047 | 0.065 |
| □ₘₐₓ (°) | 27.5 | 27.5 | 27.6 |
| Range of h, k, l | −14 → h → 14 | −16 → h → 16 | −16 → h → 16 |
| | −23 → k → 23 | −25 → k → 25 | −24 → k → 25 |
| | −11 → l → 11 | −26 → l → 26 | 0 → l → 26 |
| Refinement on | F² | F² | F² |
| R[F² > 2σ(F²)], | 0.048, 0.130, 1.07 | 0.076, 0.154, 1.10 | 0.043, 0.106, 0.96 |
| wR(F²), S | | | |
| No. of relections | 3615 reflections | 23514 reflections | 22629 reflections |
| No. of parameters | 155 | 932 | 1069 |
| H-atom treatment | Riding model, OH | Constrained to | Riding model |
| | as rigid rotor | parent site | |
| Weighting scheme | Calculated w = | Calculated w = | Calculated w = |
| | 1/[σ²(Fₒ²) + | 1/[σ²(Fₒ²) + | 1/[σ²(Fₒ²) + |
| | (0.0914P)² + | (0.0499P)² + | (0.0546P)²] where |
| | 0.3123P] where | 14.1747P] where | P = (Fₒ² + 2F_{c}²)/3 |
| | P = (Fₒ² + 2F_{c}²)/3 | P = (Fₒ² + 2F_{c}²)/3 | |
| (Δ/σ)ₘₐₓ | 0.001 | 0.001 | 0.002 |
| Δρₘₐₓ, Δρₘᵢₙ (e \check{A}⁻³) | 0.32, −0.27 | 1.45, −1.67 | 1.43, −1.08 |
| Absolute structure | Flack H D (1983), | | |
| | Acta Cryst. A39, | | |
| | 876-881 | | |
| Flack parameter | 0.07 (10) | | |

TABLE 1
lactide polymerisation data for catalyst 2 (polymerisation of rac-lactide)

| | Catalyst:monomer: | Temperature | Time | Conversion | Mₙ | |
|---|---|---|---|---|---|---|
| Reaction | solvent ratio | (° C.) | (mins) | (%) | (g/mol) | M_{w}/Mₙ |
| 1 | 1:100:10000 | −18 | 0.33 | 5 | 5000 | 1.9 |
| 2 | 1:100:10000 | −18 | 1.5 | 75 | 101000 | 1.33 |
| 3 | 1:100:10000 | −18 | 2 | 85 | 115500 | 1.41 |
| 4 | 1:100:10000 | −18 | 3 | 90 | 120000 | 1.39 |
| 5 | 1:100:10000 | −18 | 5 | 95 | 125000 | 1.40 |
| 6 | 1:100:10000 | −18 | 8 | >99 | 129000 | 1.41 |
| 7 | 1:100:10000 | −18 | 15 | >99 | 128000 | 1.43 |
| 8 | 1:200:10000 | −18 | 2 | 70 | 289000 | 1.25 |
| 9 | 1:200:10000 | −18 | 10 | >99 | 400000 | 1.31 |
| 10 | 1:100:10000^{a} | 20 | 8 | 60 | 270000 | 1.24 |
| 11 | 1:100:10000^{a} | 20 | 10 | | 216000 | 1.34 |
| 12 | 1:100:0 | 180 | 10 | >99 | 71000 | 1.91 |

Reactions 1-9: solvent = DCM (dichloromethane);
Reactions 10-11: solvent = THF (tetrahydrofurane);
Reaction 12: melt polymerization
^{a}sample purified to remove shorter chains and monomer for NMR spectroscopy

FIGS. 8-12 illustrate the Mₙ over time for reactions 1-7, Mₙ over conversion for reactions 1-7, conversion over time for reactions 1-7 and GPC data for polymer samples from reactions 8 and 9.

### NMR Spectra of Polymers

FIGS. 13A-C illustrate ¹H NMR and ¹³C NMR spectra of polymer made from D,L-lactide and 1% catalyst 2; run 10 in table 1 of polymerisation data, ESI, after 8 minutes. Mₙ=270300, PDI 1.24. The polymers were purified by precipitation from a dichloromethane solution with methanol, three times. Poly (D,L-lactide): fwhm for the methine CH resonance is 29 Hz. The integration of the iii peak in the homonuclear decoupled ¹H NMR spectrum immediately below it corresponds to 70% of the combined peak areas.

For comparison, FIGS. 14A and B illustrate spectra from polymer made using L-lactide and 1% catalyst 2; run 11 in table 1, a 10 min run, same concentrations as above with Mₙ=216000, PDI 1.34].

### Mass Spectral Analysis of Polymer

FIG. 15 illustrates the electrospray mass spectrum of a relatively short chain polymer. (cone voltage=60 V): [L(CHMeCOO)ₙH]⁺ series: 479.6, 551.6, 623.7, 695.8, 767.8, 839.8, 911.9. i.e. n=3 to 9.

### Intensity Data

EuL3-PLA polymer
Blaudeck159-1 21 (0.456) AM (Cen, 2, 80.00,
Ar, 5000.0, 734.47); Sm (SG, 3 × 5.00); Cm (16:21)

| No | Mass | Inten | % BPI | % TIC |
|---|---|---|---|---|
| 1: | 432.8 | 2.86e3 | 8.73 | 1.16 |
| 2: | 478.9 | 5.53e2 | 1.69 | 0.22 |
| 3: | 504.7 | 2.15e3 | 6.54 | 0.87 |
| 4: | 550.8 | 2.45e3 | 7.47 | 1.00 |
| 5: | 576.7 | 5.36e2 | 1.63 | 0.22 |
| 6: | 598.7 | 5.62e2 | 1.71 | 0.23 |
| 7: | 622.8 | 8.66e3 | 26.40 | 3.52 |
| 8: | 623.8 | 7.52e2 | 2.29 | 0.31 |
| 9: | 669.9 | 3.83e2 | 1.17 | 0.16 |
| 10: | 694.7 | 1.85e4 | 56.40 | 7.52 |
| 11: | 695.8 | 1.75e3 | 5.32 | 0.71 |
| 12: | 737.6 | 4.85e2 | 1.48 | 0.20 |
| 13: | 740.5 | 6.07e2 | 1.85 | 0.25 |
| 14: | 766.7 | 2.79e4 | 85.04 | 11.33 |
| 15: | 767.7 | 3.14e3 | 9.57 | 1.28 |
| 16: | 788.7 | 3.33e2 | 1.01 | 0.14 |
| 17: | 809.6 | 5.89e2 | 1.79 | 0.24 |
| 18: | 811.3 | 7.13e2 | 2.17 | 0.29 |
| 19: | 838.7 | 3.28e4 | 100.00 | 13.33 |
| 20: | 839.7 | 4.39e3 | 13.39 | 1.78 |
| 21: | 860.6 | 4.23e2 | 1.29 | 0.17 |
| 22: | 881.6 | 1.09e3 | 3.32 | 0.44 |
| 23: | 882.1 | 8.43e2 | 2.57 | 0.34 |
| 24: | 910.6 | 3.12e4 | 94.98 | 12.66 |
| 25: | 911.6 | 4.77e3 | 14.53 | 1.94 |
| 26: | 912.6 | 3.57e2 | 1.09 | 0.14 |
| 27: | 932.6 | 3.74e2 | 1.14 | 0.15 |
| 28: | 952.9 | 4.78e2 | 1.46 | 0.19 |
| 29: | 953.5 | 6.98e2 | 2.13 | 0.28 |
| 30: | 982.6 | 2.33e4 | 71.09 | 9.47 |
| 31: | 983.6 | 4.08e3 | 12.44 | 1.66 |
| 32: | 984.6 | 3.56e2 | 1.08 | 0.14 |
| 33: | 1023.9 | 3.78e2 | 1.15 | 0.15 |
| 34: | 1025.5 | 4.16e2 | 1.27 | 0.17 |
| 35: | 1040.6 | 4.05e2 | 1.23 | 0.16 |
| 36: | 1054.6 | 1.46e4 | 44.53 | 5.93 |
| 37: | 1055.6 | 3.08e3 | 9.39 | 1.25 |
| 38: | 1112.6 | 6.72e2 | 2.05 | 0.27 |
| 39: | 1126.5 | 8.12e3 | 24.75 | 3.30 |
| 40: | 1127.5 | 1.98e3 | 6.04 | 0.80 |
| 41: | 1184.5 | 7.85e2 | 2.39 | 0.32 |
| 42: | 1198.5 | 4.08e3 | 12.42 | 1.66 |
| 43: | 1199.5 | 1.25e3 | 3.81 | 0.51 |
| 44: | 1256.5 | 9.65e2 | 2.94 | 0.39 |
| 45: | 1257.5 | 3.82e2 | 1.16 | 0.16 |
| 46: | 1270.4 | 1.80e3 | 5.49 | 0.73 |
| 47: | 1271.4 | 6.74e2 | 2.05 | 0.27 |
| 48: | 1328.4 | 8.14e2 | 2.48 | 0.33 |
| 49: | 1329.4 | 3.53e2 | 1.07 | 0.14 |
| 50: | 1342.4 | 8.28e2 | 2.52 | 0.34 |
| 51: | 1343.4 | 3.96e2 | 1.21 | 0.16 |
| 52: | 1400.4 | 6.95e2 | 2.12 | 0.28 |
| 53: | 1414.4 | 4.08e2 | 1.24 | 0.17 |
| 54: | 1472.4 | 4.46e2 | 1.36 | 0.18 |

### DSC Data for PLA (Reaction 9)

FIG. 16 illustrates DSC data for PLA.

### Example 5

### Polymerisation of D,L-Lactide

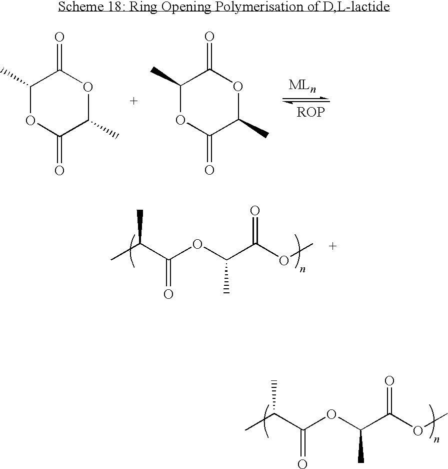

Using Catalysts Synthesis from MCl₂/HL^{R}

The complexes 4-6 have been tested as initiators for the polymerisation of D,L-lactide; two series of polymerizations were conducted:
A: D,L-lactide+[M(HL^{R})₂(Cl)₂]
B: D,L-lactide+[M(HL^{R})₂(Cl)₂] and benzyl alcohol. Benzyl alcohol was selected as coinitiator because its incorporation as benzylester end group is easily detectable by both ¹H and ¹³C NMR spectroscopy.

The polymerisations without coinitiator were conducted in toluene at 100° C. The results obtained for series A are summarized in Table 2. Low yields were obtained in all experiments.

TABLE 2
Polymerisation of rac-lactide using 6 without alcohol.

| | Cat:monomer: | | | |
|---|---|---|---|---|
| Cat | initiator ratio | T/° C. | Conv.^{a}/% | t/h |
| 6^{tBu} | 1:50:0 | 100 | 11.6 | 24 |
| 6^{Ph} | 1:50:0 | 100 | 4.4 | 24 |

To compare, polymerisations using 6^{tBu} with coinitiator were conducted in toluene at 100° C.; the results are shown in FIG. 21.

To confirm that is not the benzylalcohol polymerise the D,L-lactide, the proligand was treated with benzylalcohol which was use in polymerization of rac-lactide, the ¹H NMR spectrum show no polymerization.

Despite the fact of using a coinitiator to improve the velocity of the polymerisations, these weren't good enough. So, All reactions were carried out at 140° C., with benzyl alcohol as coinitiator to afford a melt polymerisation which the D,L-lactide is the solvent and the monomer. In the Table 3, Sn(oct)₂ is the abbreviation for Sn(octanoate)₂, the most widely industry catalyst, and thus a good reference.

TABLE 3
Polymerisation of rac-lactide using 4-6.

| | Cat:monomer: | T/ | Conv.^{a}/ | Mₙ^{b} | |
|---|---|---|---|---|---|
| Cat | initiator ratio | ° C. | % | g/mol | M_{w}/Mₙ^{c} |
| 4^{tBu} | 1:50:1 | 140 | 89 | 5300 | 1.61 |
| 4^{Ph} | 1:50:1 | 140 | 95 | 4500 | 1.88 |
| 5^{Ph} | 1:50:1 | 140 | 55 | 1100 | 2.33 |
| 5^{tBu} | 1:50:1 | 140 | 97 | 1300 | 1.42 |
| 6^{tBu} | 1:50:1 | 140 | 69 | 4400 | 1.19 |
| 6^{Ph} | 1:50:1 | 140 | 55 | 1100 | 2.33 |
| Sn(oct)₂ | 1:50:1 | 140 | 24 | 700 | 1.13 |

^{a}conversion of LA monomer (([LA]₀ − [LA])/[LA]₀), calculated by ¹H NMR;
^{b}measured by GPC, values based on polystyrene standards and corrected by multiplication by 0.47 (Mark-Houwink law);
^{c}polydispersity index (M_{w}/Mₙ), PDI, measured by GPC.

The polymerisations using 5 show that at 2% catalyst loading the polymerisation are slow, the molecular weights are low (below 2000 g·mol⁻¹), and the PDIs fluctuate between 1.3-2. On the other hand, the kinetic data for Mₙ versus conversion show that the kinetics for the three complexes appears to be living.

The polymerisations using 4 show the best results so far; high molecular weight (15000-20000 g·mol⁻¹) although the polydispersities are not narrow around 1.6-1.8. Also, the kinetic traces show a living nature with a linear Mₙ versus conversion and PDI decreases with an increasing conversion.

The polymerisation using 6 are difficult to analyse and inconsistent; generally the polymerisation rates were slow and the molecular weights low. The polymerisations using Sn(oct)₂ are very slow in comparison, furthermore they are not living.

The GPC chromatogram of FIG. 22 shows that the polymerisations with 4^{tBu} and 4^{Ph} have the highest molecular weight, and 6^{tBu} has the narrow PDI. On the other hand 6^{Ph} and Sn(oct)₂ have low molecular weight and high PDI.

The aim of this project is to polymerise a mixture of two stereocomplex PLA, poly-D-lactide and poly-L-lactide. Two separate control experiments were performed to confirm the tacticity, so it was decided that 4^{tBu} will be use to extend the studies

In the first control experiment, the ¹H NMR spectra of the stereocomplex product should look like that of poly-L-lactide, with a single CHMe resonance (if the chains are infinitely long). If the polymerisation is less selective or transterification becomes a competing reaction at higher conversions, the original stereochemical control will be lost and the proton-decoupled spectra will show the different CH environments. L-lactide was polymerised using 4^{tBu} (FIG. 23a), D,L-lactide was polymerised using 4^{tBu} (FIG. 23b) and was compared to the rac-PLA polymerised with Sn(Oct)₂ (FIG. 23c).

The shape of the NMR spectra samples of rac-lactide polymerised by 4^{tBu} at 89% monomer conversion, (23b) are comparable to (23c) with the iii resonance corresponding to 35% of the combined peak areas, indicating a poor stereoselectivity of the polymerisation. It contains major additional resonances corresponding to unselective insertions.

In the second experiment, the ¹³C NMR spectra of the stereocomplex product should look like that of poly-L-lactide, with a single CHMe resonance (if the chains are infinitely long). If there have been transferication reactions, or unselective insertions, the control will be lost and the NMR spectra will contain resonances for the different CH environments.

Spectra samples of rac-lactide polymerised by 4^{tBu} at 89% monomer conversion, (24b) are a shape different to (24a) confirming a poor stereoselectivity of the polymerisation. It contains major additional resonances corresponding to unselective insertions.

The GPC data and ¹H NMR spectra show a linear variation between Mₙ and conversion and between Ln (1/(1-conv.)) and the time of polymerisation that indicates a controlled, living polymerization (FIGS. 25A and B); also the PDI is below 1.4. Furthermore, chains extension is possible by reactivation of the end groups. The theoretical molecular weights have been calculated using the formula:

$${M}_{n theo} = \frac{{[ M ]}_{0}}{{2 [ A ]}_{0}} \times 144.13 \times conv .$$

Any polymerisations were tried using a catalyst synthesise from MCl₂/LiL^{R}

Using Catalysts Synthesis from MN″ₙ/HL^{R}

The complex 8^{Ph} was examined for polymerisation activity with rac-lactide (M/I=50). The polymerisations were carried out in bulk at 140° C. with coinitiator. From the polymerisation data, it is apparent than the calcium complex shows at full conversion (>95%) a narrow distribution (1.2-1.3) but a low molecular weights (around 1000-2000 g·mol⁻¹). Some studies are carrying out with 8^{tBu}.

The conversion versus the time of polymerisation using 8^{Ph} is shown in FIG. 26.

Previously in our group (Robert Blaudeck), the complex 12^{tBu} has been tested as an initiator for the polymerization of rac-lactide (M/I=100); even at −18° C. in DCM, the polymerisation is rapid, and appears to be living in nature. The polymer weights are high (22 100 g·mol⁻¹ at 35% of conversion and 68 600 g·mol⁻¹ at 99%), and the polydispersities (PDI) of the polymers are narrow (1.3-1.5). Approximately half of the monomer is consumed after three minutes, during which the solution becomes extremely viscous. He also proved that with increasing M/I he obtained a decrease in the PDI (around 1.2).

Using Catalysts Synthesis from MRₙ/HL^{R}

The complexes synthesis from ZnEt₂ and AlMe₃ yielded with so much compound that it was impossible to use the complexes 9 and 10 in polymerisation, only the complex 11 was used.

The complex 11^{tBu} was examined for polymerisation activity with rac-lactide (M/I=50). The polymerisations were carried out in toluene at 100° C. with coinitiator. From the polymerisation data, it is apparent than the aluminium complex shows a conversion >90%, a large distribution (1.7-1.9), and a low molecular weights (around 1000-2000 g·mol⁻¹). The conversion versus the time of polymerisation using 11^{tBu} is shown in FIG. 27.

### Example 6

### Copolymerisation of L-Lactide/Glycolide

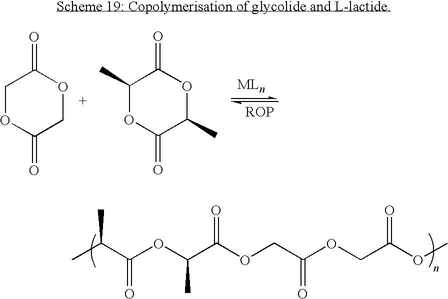

All the copolymerisation between L-lactide and glycolide were carried out only with complexes 4-6: [M(HL^{R})₂(Cl)₂]

### Kinetic Study

To understand the kinetic of copolymerisation between L-lactide and glycolide, different factors were changed, the metal (Mg, Zn, Sn); the ligand (tert-butyl, phenyl or octanoate); the time of polymerisation (from 10 seconds to 96 h); the feed composition (from 100% of L-lactide to 100% of glycolide); and the temperature (140° C., 160° C. or 180).

A kinetic study was carried out to find the best combination of factors. The initial conditions were: 5^{Ph}, 140° C., 96 h, [Lac]/[Gly]=4, [Lac]/[Cat]=50.

Firstly, after 1.5 h reaction time the reaction is 64% complete and after 24 h it is 85%. Secondly, the feed composition gives the best results for a ratio 60/40 (L-lactide/glycolide). Thirdly, the conversion rate increases with increasing temperature. And the rate is also dependent on the ligand following the order ^{t}Bu>Ph>octanoate. Finally, the metal affects the rate following the order Mg>Zn>Sn.

The best combination found was: 4^{tBu}, 140° C., 24 h, [Lac]/[Gly]=1.5 [Lac]/[Cat]=50, this combination was used in microstructure studies.

### Copolymer Microstructure

At the beginning of the polymerisation, the ¹H NMR spectra of the copolymer product should show just -GGGGG- pentads because the glycolide, is polymerised faster than the L-lactide; with increasing time, some -LLGGL- pentads should emerge. If the copolymerisation is less selective, no stereochemical control will be observed and the microstructure will show a different tacticity.

By applying the probability theory to the estimation of copolymer sequence distribution we expected completely random copolymer with a <<blocking >> tendency (χ<1). This is confirmed by the results of ¹H NMR spectra which have shown a block tendency after 6 h (-GGGGG-) and some atactic pentades after 24 h (-LLGGL-+-LGGLL-), also confirmed by the presence of atactic tetrads after 24 h (-GGLL-) in the ¹³C NMR (FIG. 28).

### GPC Characterisations

The GPC data (FIG. 29) show a linear variation between Mₙ and conversion but not through 0 and that indicates a controlled, living polymerisation; also the PDI is below 1.6 that is good for a copolymerisation. The ¹H NMR spectra show as predicted by theory, a polymerisation faster for the glycolide than for the L-lactide. The theoretical molecular weights have been calculated using the formula:

$${M}_{n theo} = ( {x}_{L \text{-} Lac} \times {M}_{L \text{-} Lac} + {x}_{Gly} \times {M}_{Gly} ) \times conv . \times \frac{{[ {M}_{L \text{-} Lac} ]}_{0} + {[ {M}_{Gly} ]}_{0}}{{[ Cat ]}_{0}}$$

The kinetic results are shown as a stacked plot on GPC chromatograms to demonstrate the dependence of the molecular weights with the conversion (FIG. 30).

The GPC chromatograms confirm the results from FIG. 29; with increasing time of the polymerisation there is an increase in the molecular weights. Meanwhile, the PDI increases with an increase in the time of the polymerisation.

### Example 7

### Polymerisation of Lactide

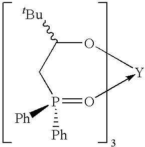

TABLE 4
polymerization of rac-lactide by YL₃^{Ph}.

| | Cat:monomer: | | | |
|---|---|---|---|---|
| entry | solvent ratio^{a} | T/° C. | Time/min | Conv.^{b}/% |
| 1 | 1:100:10000 | −10 | 0.33-1 | >99 |
| 2 | 1:100:10000 | −10 | 3 | >99 |
| 3 | 1:100:10000 | −10 | 6 | >99 |
| 4 | 1:100:10000 | −10 | 10 | >99 |

^{a}solvent = dichloromethane;
^{b}conversion of LA monomer (([LA]₀ − [LA])/[LA]₀).
^{c}measured by GPC, values based on polystyrene standards, weight corrected by multiplication by 0.47 [Mark-Houwink equation]
^{d}polydispersity index (Mw/Mn), PDI, measured by GPC.

The polymers were characterized by NMR spectroscopy. The results are shown in FIGS. 31a-e.

a) methine region of the homonuclear decoupled ¹H-NMR for entry 1. Integration of the iii peak corresponds to 26.2%.

¹H-NMR δ(CDCl₃): 5.146, 5.161, 5.171, 5.178, 5.181, 5.185, 5.202 [ppm].

b) methine region of the homonuclear decoupled ¹H-NMR for entry 2. Integration of the iii peak corresponds to 88.8%.

¹H-NMR δ(CDCl₃): 5.103, 5.181, 5.200 [ppm].

c) methine region of the homonuclear decoupled ¹H-NMR for entry 3. Integration of the iii peak corresponds to 78.7%.

¹H-NMR δ(CDCl₃): 5.144, 5.160, 5.178, 5.198, 5.211, [ppm].

d) methine region of the homonuclear decoupled ¹H-NMR for entry 4. Integration of the iii peak corresponds >99%.

¹H-NMR δ(CDCl₃): 5.151 ppm.

TABLE 5
polymerization of rac-lactide by ZnL₂^{Ph}.

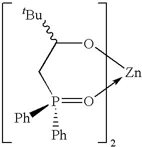

| | Cat:monomer: | | | Conv.^{b}/ | | |
|---|---|---|---|---|---|---|
| entry | solvent ratio^{a} | T/° C. | Time/h | % | Mₙ^{c}g/mol | M_{w}/Mₙ^{d} |
| 5 | 1:50:0 | 140 | 72 | >99 | | |

^{a}solvent = dichloromethane;
^{b}conversion of LA monomer (([LA]₀-[LA])/]LA]₀).
^{c}measured by GPC, values based on polystyrene standards, weight corrected by multiplication by 0.47 [Mark-Houwink equation]
^{d}polydispersity index (Mw/Mn), PDI, measured by GPC.
e) methine region of the homonuclear decoupled ¹H-NMR for entry 5. Integration of the iii peak corresponds to 36.1%.
¹H-NMR δ(CDCl₃): 5.097, 5.126, 5.139, 5.165, 5.179, [ppm].

### Example 8

### Polymerisation of ε-Caprolactone

### Polymerization Procedures

Solution:

A teflon valve-sealed ampoule was charged with 500 mg of the monomer which was dissolved in the volume of thf required to give the ratio in the table entry, and the solution stirred at the temperature given in the table. To this was added via cannula a solution of appropriate mass of catalyst (one of 1 to 4) in 2 mls of thf (see table 6).

Melt:

The catalyst (one of 1 to 4) was ground using a pestle and mortar to a fine powder, which was mixed with the powdered monomer in a flask in the quantities 500 mg ε-caprolactone and the appropriate mass of catalyst (see table 6).

The mixture was heated in an ampoule in a sand bath to 180 centigrade. The powder melted into a viscous solution which solidified as it cooled down to RT.

Yield 99% (apparent complete conversion).

TABLE 6
polymerization of e-caprolactone by ErL₃.

| | Temp/ | Time/ | | | | |
|---|---|---|---|---|---|---|
| Cat:Monomer:Solvent | ° C. | mins | Mw | Mn | PDI | Mp |
| 1:100:5,000/ε- | 20 | 120 | 149000 | 121000 | 1.23 | 120 |
| caprolactone | | | | | | |
| 1:100:5,000/ε- | 20 | 240 | 381000 | 230000 | 1.65 | 200 |
| caprolactone | | | | | | |
| 1:50:5,000/ε- | 20 | 10 | 149000 | 112000 | 1.32 | — |
| caprolactone | | | | | | |
| 1:50:0*/ε- | 20 | 10 | 284000 | 155000 | 1.83 | 180 |
| caprolactone | | | | | | |

*melt: powdered catalyst dissolved in monomer - solidified after 10 mins

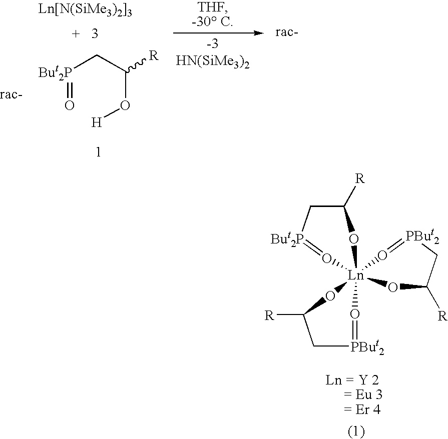

### Example 9

### Preparation of Poly β-Caprolactam

A vigorously stirred solution of 0.5 g (4.4 mmol) ε-caprolactam in 50 ml thf was treated with an solution of 5 mg ErL₃ in 1 ml thf at room temperature. After 30 min the reaction mixture was quenched with 5 drops of MeOH. Removing the solvent yielded white amorphous polymer. Mₙ=101000 g/mol, PDI=1.4

What is claimed is:

1. A compound of Formula (I), (II) (III), (IV), (V) or (VI): 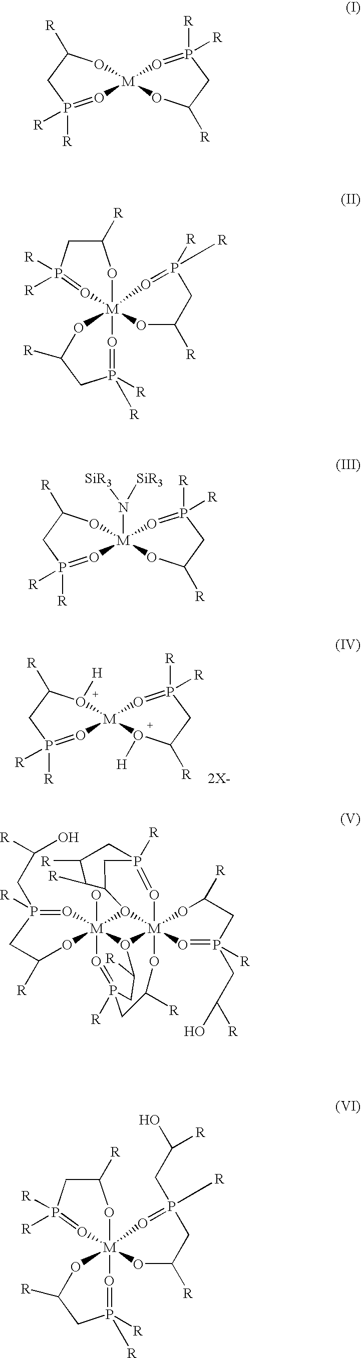
wherein R is independently selected at each occurrence from the group comprising:
hydrogen, hydrocarbyl and substituted hydrocarbyl;
M is a Lewis-acidic metal;
and, if present, X is any suitable counter ion.

2. A compound as claimed in claim 1, of Formula (I), (II) (III), (IV), (V) or (VI): 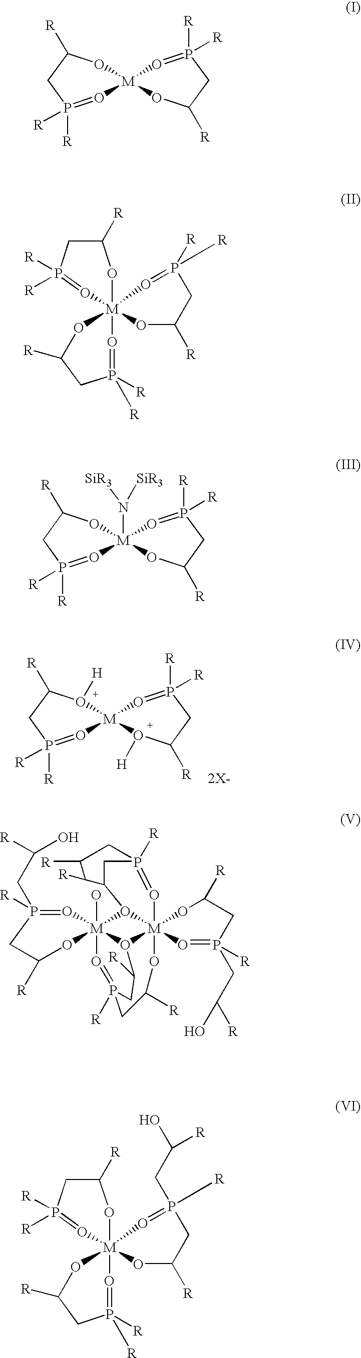
where R is independently selected from the group consisting of hydrogen, hydrocarbyl or substituted hydrocarbyl;
M is a Lewis-acidic metal selected from the group comprising: lithium, beryllium, sodium, magnesium, potassium, calcium, rubidium, strontium, caesium, barium, francium, radium, scandium, titanium, vanadium, chromium, manganese, iron, cobalt, nickel, copper, zinc, yttrium, zirconium, tin, aluminium, lanthanum, cerium, praseodymium, neodymium, samarium, europium, gadolinium, terbium, dysprosium, holmium, erbium, thulium, ytterbium, lutetium, thorium, protactinium, uranium, neptunium, plutonium, americium, curium, berkelium, californium, einsteinium, fermium, mendelevium, nobelium and lawrencium;
and X is a halogen.

3. A compound as claimed in claim 1, wherein the complex is useful for polymerisation of carbonyl-containing or cyclic monomers.

4. A compound as claimed in claim 1, wherein M is a metal selected from the group comprising: Mg, Zn, Sn, Ca, Al, Y, Yb, Er or Eu.

5. A compound as claimed in claim 1, wherein M is a Lewis-acidic metal selected from the f-block of the periodic table of elements.

6. A compound as claimed in claim 4, wherein M is selected from the lanthanide series of metals.

7. A compound as claimed in claim 1, wherein each R is independently selected from the group comprising (C1-C δ)alkyl, (C2-C6)alkenyl, (C2-C6)alkynyl, 5- or 6-membered-heteroaryl containing 1 or 2 ring heteroatoms independently selected from the group consisting of N, S or O and aryl.

8. A compound as claimed in claim 1, wherein each R is independently a Ci-4 alkyl or aryl.

9. A compound as claimed in claim 1, wherein X is chlorine.

10. A compound as claimed in claim 9, having the formula: 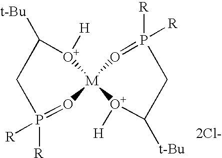
wherein R is independently selected at each occurrence from the group comprising hydrogen hydrocarbyl, and substituted hydrocarbyl.

11. A compound as claimed in claim 10, wherein M is Mg, Zn or Sn.

12. A compound as claimed in claim 10, having the formula:

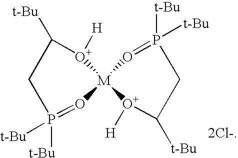

13. A compound as claimed in claim 12, having the formula:

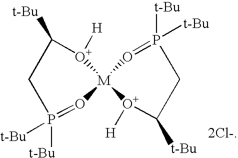

14. A compound as claimed in claim 10, having the formula:

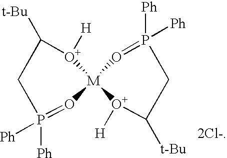

15. A compound as claimed in claim 1, having the formula: 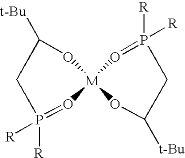
wherein R is independently selected at each occurrence from the group comprising hydrogen, hydrocarbyl, and substituted hydrocarbyl.

16. A compound as claimed in claim 15, wherein M is a metal selected from the group comprising: Zn and Ca.

17. A compound as claimed in claim 15, having the formula:

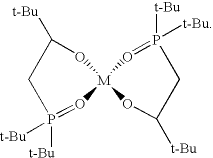

18. A compound as claimed in claim 15, having the formula:

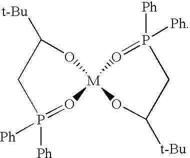

19. A compound as claimed claim 1, having the formula:

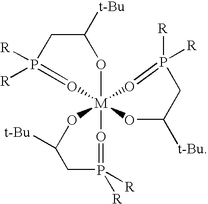

20. A compound as claimed in claim 19, wherein M is a metal selected from the group comprising: Al, Y, Yb, Er and Eu.

21. A compound as claimed in claim 19, having the formula:

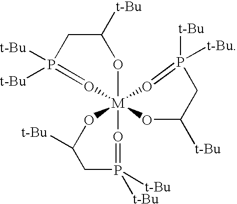

22. A compound as claimed in claim 19, having the formula:

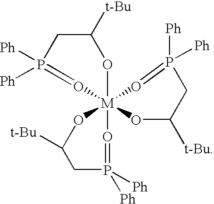

23. A method of using a compound as claimed in claim 1, comprising: performing stereoselective polymerisation of carbonyl-containing or cyclic monomers.

24. The method as claimed in claim 23, wherein the carbonyl-containing or cyclic monomers are D-lactide and L-lactide.

25. The method as claimed in claim 23, wherein the carbonyl-containing or cyclic monomers are L-lactide and glycolide.

26. A method of using a compound as claimed in claim 1, comprising: performing polymerisation of carbonyl-containing or cyclic monomers.

27. The method as claimed in claim 26, wherein the carbonyl-containing or cyclic monomer is ε-caprolactone.

28. The method as claimed in claim 26, wherein the carbonyl-containing or cyclic monomer is ε-caprolactam.

29. The method of using a compound as claimed in claim 1, comprising:
creating asymmetric Lewis-acid catalysed reactions.
